(19) United States
(12) Patent Application Publication
(10) Pub. No.: US 2017/0325453 A1
(43) Pub. Date: Nov. 16, 2017

(54) Herbicidal Mixtures for Controlling Herbicide-Resistant Dicotyledonous Plants

(71) Applicants: BASF AGRO B.V., Amhem (NL); Universidade Estadual de Maringa, Maringa (BR)

(72) Inventors: Rafael Brugnera BELANI, Sao Paulo (BR); Hernan Oscar GHIGLIONE, Funes (AR); Sergio ZAMBON, Piracicaba (BR); Everson Pedro ZENY, Londrina (BR); Jamil CONSTANTIN, Maringa PR (BR); Rubem Silverio DE OLIVEIRA, Jr., Jardim Aclimacao (BR); Denis Fernando BIFFE, Maringa PR (BR)

(21) Appl. No.: 15/527,774

(22) PCT Filed: Nov. 23, 2015
(86) PCT No.: PCT/EP2015/077300

§ 371 Date: May 18, 2017

Related U.S. Application Data
(60) Provisional application No. 62/083,359, filed on Nov. 24, 2014.

(30) Foreign Application Priority Data
Apr. 9, 2015 (EP) 15162901.1

(51) Int. Cl. A01N 43/50; A01N 57/20; A01N 43/54

(52) U.S. Cl. CPC A01N 43/50; A01N 43/54; A01N 57/20

(57) ABSTRACT

The present invention relates to herbicidal mixtures which comprise
a) a herbicide A, which is glyphosate or an agriculturally acceptable salt thereof, b) a herbicide B which is saflufenacil or an agriculturally salt thereof, and c) at least one herbicide C which is an imidazolinone or an agriculturally acceptable salt thereof, their use for controlling herbicide resistant, in particular glyphosate-resistant, weeds and crops and methods for controlling herbicide resistant weeds or crops.

The present invention relates to herbicidal mixtures which comprise

a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof.

In particular, the invention refers to the use of a herbicidal composition comprising:
a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof; for controlling undesirable vegetation in crop plants.

Accordingly, the invention refers to a method for controlling undesirable vegetation, which comprises allowing a herbicidal composition comprising:

a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof;
to act on herbicide resistant plants or their habitat in crop plants.

Herbicide resistant weeds, such as weeds resistant to glyphosate, dicamba, 2,4-dichlorophenoxyethanoic acid, glufosinate, ACCase inhibitors, HPPD inhibitors and/or acetohydroxyacid synthase inhibitors, present a serious problem for efficient weed control because such resistant weeds are increasingly widespread and because weed control by the application of herbicides is no longer effective. In particular, glyphosate resistant weeds, like Conyza spp., are a huge problem to farmers. Furthermore, in certain situations herbicide resistant crops, such as crops resistant to glyphosate, dicamba, 2,4-dichlorophenoxyethanoic acid, glufosinate, ACCase inhibitors, HPPD inhibitors and/or acetohydroxyacid synthase inhibitors, can present a serious problem when they adventitiously germinate (“volunteer crops”) and grow in a subsequent rotational crop which itself is herbicide resistant, e.g. glyphosate resistant, and in which weed control is achieved by the application of herbicide, e.g. glyphosate. In particular Roundup Ready canola, cotton, alfalfa, soybean, sunflower or sugarbeets have been a problem in crop rotation. There is thus a need for an effective and efficient method for the control of herbicide resistant weeds or crops.

In crop protection, it is in principle desirable to increase the specificity and the reliability of the action of active compounds. In particular, it is desirable for the crop protection product to control the harmful plants effectively and, at the same time, to be tolerated by the useful plants in question.

N-(phosphonomethyl)glycine (common name: glyphosate; formula I) is an active compound from the group of organophosphorus herbicides which are known e.g. from The Compendium of Pesticide Common Names http://www.alanwood.net/pesticides/.

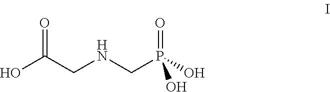

N′-{2-chloro-4-fluoro-5-[1,2,3,6-tetrahydro-3-methyl-2,6-dioxo-4-(trifluoromethyl)pyrimidin-1-yl]benzoyl}-N-isopropyl-N-methylsulfannide (common name: saflufenacil, formula II) is an active compound from the group of phenyluracils, which are known e.g. from The Compendium of Pesticide Common Names http://www.alanwood.net/pesticides/.

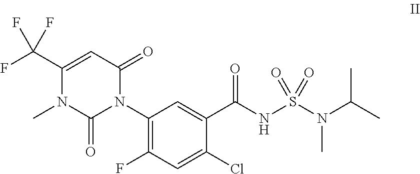 [SMILES: CC(C)N(C)S(=O)(=O)NC(=O)c1cc(-n2c(=O)cc(C(F)(F)F)n(C)c2=O)c(F)cc1Cl]

It is an object of the present invention to provide herbicidal compositions, which show herbicide action against undesired vegetation, such as herbicide resistant dicotyledonous weeds, in particular glyphosate resistant dicotyledonous weeds, such as Conyza spp. or glyphosate resistant dicotyledonous volunteer crops.

This object is achieved, by herbicidally active compositions comprising

a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof.

The invention relates in particular to compositions in the form of herbicidally active compositions as defined herein.

The invention furthermore relates to the use of compositions as defined herein for controlling herbicide resistant plants. The invention refers to controlling herbicide resistant weeds and herbicide resistant volunteer crops.

The invention furthermore relates to the use of compositions as defined herein for controlling acetohydroxyacid synthase inhibitor resistant and/or glyphosate resistant plants. The invention refers to controlling acetohydroxyacid synthase inhibitor resistant and/or glyphosate resistant weeds and acetohydroxyacid synthase inhibitor resistant and/or glyphosate resistant volunteer crops.

The invention refers to controlling herbicide resistant monocotyledonous plants and herbicide resistant dicotyledonous plants. Particularly, the invention relates to controlling herbicide resistant monocotyledonous plants, more particularly to glyphosate-resistant monocotyledonous plants, such as glyphosate-resistant monocotylenonous weeds or glyphosate-resistant monocotyledonous volunteer crops. Particularly, the invention relates to controlling herbicide resistant dicotyledonous plants, more particularly to glyphosate-resistant dicotyledonous plants, such as glyphosate resistant dicotyledonous weeds or glyphosate resistant dicotyledonous volunteer crops.

In particular, the invention relates to the use of compositions as defined herein for controlling glyphosate-resistant monocotyledonous weeds, preferably Digitaria spp.

One embodiment of the invention relates to the use of compositions as defined herein for controlling Digitaria insularis.

In particular, the invention relates to the use of compositions as defined herein for controlling glyphosate-resistant dicotyledonous weeds, preferably Conyza spp.

One embodiment of the invention relates to the use of compositions as defined herein for controlling Conyza bonariensis and/or Conyza sumatrensis.

In particular, the invention relates to the use of compositions as defined herein for controlling glyphosate-resistant dicotyledonous volunteer crops, preferably soybean, cotton, canola, alfalfa, sugarbeet and sunflowers. In particular, the invention relates to the use of compositions as defined herein for controlling undesirable vegetation in soybean, cotton, canola, alfalfa, sugarbeet and sunflowers, preferably in soybean.

When using the compositions of the invention for this purpose the herbicide A, the herbicide B and the at least one herbicide C can be applied simultaneously or in succession in crops, where undesirable vegetation may occur.

One embodiment of the invention relates to the use of the compositions as defined herein for controlling herbicide resistant weeds or volunteer crops in crop plants, in particular leguminous crops, more particularly soybean.

One embodiment of the invention relates to the use of the compositions as defined herein for controlling herbicide resistant monocotyledonous weeds or monocotyledonous volunteer crops in crop plants, in particular leguminous crops, more particularly soybean.

One embodiment of the invention relates to the use of the compositions as defined herein for controlling herbicide resistant dicotyledonous weeds or dicotyledonous volunteer crops in crop plants, in particular leguminous crops, more particularly soybean.

Another embodiment of the invention relates to the use of the compositions as defined herein for controlling glyphosate resistant weeds or volunteer crops in crop plants, in particular leguminous crops, more particularly soybean.

Another embodiment of the invention relates to the use of the compositions as defined herein for controlling glyphosate resistant monocotyledonous weeds or monocotyledonous volunteer crops in crop plants, in particular leguminous crops, more particularly soybean.

Another embodiment of the invention relates to the use of the compositions as defined herein for controlling glyphosate resistant dicotyledonous weeds or dicotyledonous volunteer crops in crop plants, in particular leguminous crops, more particularly soybean.

The invention furthermore relates to the use of compositions as defined herein for controlling undesirable vegetation in crops which, by genetic engineering or by breeding, are tolerant to one or more herbicides (e.g. glyphosate or acetohydroxyacid synthase inhibiting herbicides such as imidazolinones, and/or pathogens (such as plant-pathogenous fungi), and/or to attack by insects; preferably tolerant to one or more herbicides that act as acetohydroxyacid synthase inhibitors.

The invention furthermore relates to a method for controlling undesirable vegetation, the method comprises applying an herbicidal composition according to the present invention to the undesirable plants. Application can be done before, during and/or after the emergence of the undesirable plants. The herbicide A, the herbicide B and the at least one herbicide C can be applied simultaneously or in succession.

The invention relates to a method for controlling herbicide resistant weeds or volunteer crops in crops which comprises applying an herbicidal composition according to the present invention to crops where said herbicide resistant weeds or volunteer crops occur or might occur.

The invention particularly relates to a method for controlling herbicide resistant monocotyledonous weeds or monocotyledonous volunteer crops in crops which comprises applying an herbicidal composition according to the present invention to crops where said herbicide resistant monocotyledonous weeds or monocotyledonous volunteer crops occur or might occur.

The invention particularly relates to a method for controlling herbicide resistant dicotyledonous weeds or dicotyledonous volunteer crops in crops which comprises applying an herbicidal composition according to the present invention to crops where said herbicide resistant dicotyledonous weeds or dicotyledonous volunteer crops occur or might occur.

The invention furthermore relates to a method for controlling herbicide resistant weeds or volunteer crops, which comprises allowing a composition according to the present invention to act on plants, their habitat or on seed.

The invention furthermore relates to a method for controlling herbicide resistant moncotyledonous weeds or monocotyledonous volunteer crops, which comprises allowing a composition according to the present invention to act on plants, their habitat or on seed.

The invention furthermore relates to a method for controlling herbicide resistant dicotyledonous weeds or dicotyledonous volunteer crops, which comprises allowing a composition according to the present invention to act on plants, their habitat or on seed.

The invention in particular relates to a method for controlling glyphosate resistant weeds or volunteer crops, which comprises applying an herbicidal composition according to the present invention to crops where glyphosate resistant weeds or volunteer crops occur or might occur.

The invention in particular relates to a method for controlling glyphosate resistant monocotyledonous weeds or monocotyledonous volunteer crops, which comprises applying an herbicidal composition according to the present invention to crops where glyphosate resistant monocotyledonous weeds or monocotyledonous volunteer crops occur or might occur.

The invention in particular relates to a method for controlling glyphosate resistant dicotyledonous weeds or dicotyledonous volunteer crops, which comprises applying an herbicidal composition according to the present invention to crops where glyphosate resistant dicotyledonous weeds or dicotyledonous volunteer crops occur or might occur.

The invention furthermore relates to a method for controlling glyphosate resistant weeds or volunteer crops, which comprises allowing a composition according to the present invention to act on plants, their habitat or on seed.

The invention furthermore relates to a method for controlling glyphosate resistant monocotyledonous weeds or monocotyledonous volunteer crops, which comprises allowing a composition according to the present invention to act on plants, their habitat or on seed.

The invention furthermore relates to a method for controlling glyphosate resistant dicotyledonous weeds or dicotyledonous volunteer crops, which comprises allowing a composition according to the present invention to act on plants, their habitat or on seed.

In the methods of the present invention it is immaterial whether the combination of herbicide A, herbicide B and the at least one herbicide C are formulated and applied jointly or separately, and, in the case of separate application, in which order the application takes place. It is only necessary, that the combination of herbicide A, herbicide B and the at least one herbicide C are applied in a way, which allows simultaneous action of the active ingredients on the plants.

The invention also relates to an herbicide formulation, which comprises a herbicidally active composition as defined herein and at least one carrier material, including liquid and/or solid carrier materials.

It is believed that the compositions according to the invention have better herbicidal activity against harmful plants than would have been expected by the herbicidal activity of the individual compounds. In other words, the joint action of herbicide A, herbicide B and/or the at least one herbicide C results in an enhanced activity against harmful plants in the sense of a synergy effect (synergism). For this reason, the compositions can, based on the individual components, be used at lower application rates to achieve an herbicidal effect comparable to the individual components. The compositions of the invention also show an accelerated action on harmful plants, i.e. damaging of the harmful plants is achieved more quickly in comparison to application of the individual herbicides. Moreover, the compositions according to the invention are effective in reducing regrowth of emerged plants and the emergence of new plants, in particular herbicide resistant weeds, such as glyphosate resistant weeds. Apart from that, the compositions of the present invention show good crop compatibility, i.e. their use in crops leads to a reduced damage of the crop plants.

As used herein, the terms “controlling” and “combating” are synonyms.

As used herein, the terms “undesirable vegetation”, “harmful plants” and “weeds” are synonyms.

As used herein, the term “herbicide resistant” refers to plants that are resistant to herbicides for example, but not limited to, glyphosate, dicamba, 2,4-dichlorophenoxyethanoic acid, glufosinate, ACCase inhibitors, HPPD inhibitors and/or acetohydroxyacid synthase inhibitors.

The terms “species” and “spp.” as used herein are interchangeable.

The abbreviation “c.p.” stands for “commercial product”.

The abbreviation “a.e.” stands for “acid equivalent”.

The abbreviation “a.i.” stands for “active ingredient”.

The term “imidazolinones” includes inter alia, but is not limited to, imazamethabenz, imazamox, imazapic, imazapyr, imazaquin and imazethapyr.

The term “dicotyledonous” refers to plants that have a pair of leaves (cotyledons) in the embryo of the seed.

The term “monocotyledonous” refers to pants that produce only one leave (cotyledon) in the embryo of the seed.

If the herbicides A, the herbicides B, the herbicides C and/or the safeners (see below) have functional groups which can be ionized, they can also be used in the form of their agriculturally acceptable salts. In general, the salts of those cations or the acid addition salts of those acids are suitable whose cations and anions, respectively, have no adverse effect on the action of the active compounds. Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium. Reference to a salt includes the anhydrous form as well as hydrated forms thereof.

In the compositions according to the invention, the compounds that carry a carboxyl group can also be employed in the form of agriculturally acceptable derivatives, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Preferred mono- and di-C₁-C₆-alkylamides are the methyl- and the dimethylamides. Preferred arylamides are, for example, the anilidines and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester. Preferred derivatives are the esters.

Reference to glyphosate include acids or salts such as alkaline or earth alkaline metals or ammonium or organoammonium salts, for instance, sodium, potassium, ammonium and isopropyl ammonium. Examples for glyphosate salts are glyphosate-diammonium, glyphosate-dimethylammonium, glyphosate-isopropylammonium, glyphosate-monoammonium, glyphosate-potassium, glyphosate-sesquisodium, glyphosate-trimesium, glyphosate ethanolamine, glyphosate trimethylsulfonium and glyphosate triethanolamine.

In particular the term imidazolinone herbicide or reference to specific imidazolinone herbicides herein, such as, imazamethabenz, imazamox, imazapic (e.g. Kifix), imazapyr, imazaquin and imazethapyr, include acids or salts such as alkaline or earth alkaline metals or ammonium or organoammonium salts, for instance, sodium, potassium, ammonium and isopropyl ammonium. Examples for isopropyl ammonium salts are diisopropyl ammonium- or monoisopropyl ammonium salts. Preferred is imazapyr ammonium salt, imazapic ammonium salt, imazamox ammonium salt and imazethapyr ammonium salt. More preferred is imazapyr ammonium salt, imazapic ammonium salt, and imazethapyr ammonium salt. Particularly preferred is imazapyr ammonium salt, imazapic ammonium salt. Examples for acids are 2-(4-isopropyl-4-methyl-5-oxo-2-imidazolin-2-yl)-nicotinic acid; [2-(4-isopropyl)-4-] [methyl-5-oxo-2-imidazolin-2yl)-3-quinolinecarboxylic] acid; [5-ethyl-2-(4-isopropyl-] 4-methyl-5-oxo acid; 2-(4-isopropyl-4-methyl-5-oxo-2-imidazolin-2-yl)-5-(methoxymethyl)-nicotinic acid; [2-(4-isopropyl-4-methyl-5-oxo-2-]imidazolin-2-yl)-5-m acid.

In one embodiment the at least one herbicide C is an imidazolinone except imazamox.

In one embodiment the at least one herbicide C refers to a mixture of methyl [6-(4-isopropyl-4-]methyl-5-oxo-2-imidazolin-2-yl)-m-toluate and methyl [2-(4-isopropyl-4-]methyl-5-oxo-2-imidazolin-2-yl)-p-toluate.

In another embodiment the at least one herbicide C refers to 5-ethyl-2-(4-isopropyl-4-methyl-5-oxo-2-imidazolin-2-yl)-nicotinic acid and [2-(4-isopropyl-4-methyl-5oxo-2-imidazolin-2-]yl)-5-(methoxymethyl)-nicotinic acid.

In a preferred embodiment the imidazolinone herbicide is [2-(4-isopropyl-4-]methyl-5-oxo-2-imidazolin-2-yl)-5-(methoxymethyl)-nicotinic acid.

In one embodiment the at least one herbicide C refers to mixtures of imidazolinones, such as mixtures of imazapic and imazapyr (e.g. Onduty® or Soyvance®).

In one embodiment the at least one herbicide C is selected from the group consisting of imazapyr, imazapic, imazamox and imazethapyr or their agriculturally acceptable salts thereof. Preferably, the at least one herbicide C is imazapyr or an agriculturally acceptable salt thereof or imazapic or an agriculturally acceptable salt thereof. More preferred, the herbicides C are a combination of imazapyr or agriculturally acceptable salt thereof and imazapic or an agriculturally acceptable salt thereof.

If the herbicides A, herbicides B, herbicides C and/or the safeners are capable of forming geometrical isomers, for example E/Z isomers, it is possible to use both the pure isomers and mixtures thereof in the compositions according to the invention. If the herbicides A, herbicides B, herbicides C and/or the safeners have one or more centers of chirality and, as a consequence, are present as enantiomers or diastereomers, it is possible to use both the pure enantiomers and diastereomers and their mixtures in the compositions according to the invention.

In a specific embodiment the herbicidal composition comprises

a) a herbicide A which is glyphosate or an agriculturally acceptable salt thereof,
b) a herbicide B which is saflufenacil or an agriculturally acceptable salt thereof, and
c) at least one herbicide C which an imidazolinone or an agriculturally acceptable salt thereof.

In another specific embodiment the herbicidal composition comprises

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts.

In another specific embodiment the herbicidal composition comprises

a) a herbicide A which is glyphosate or an agriculturally acceptable salt thereof,
b) a herbicide B which is saflufenacil or an agriculturally acceptable salt thereof, and
c) at least one herbicide C which is imidazolinone or an agriculturally acceptable salt thereof except imazamox.

In another specific embodiment the herbicidal composition comprises

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, and imazethapyr or their agriculturally acceptable salts.

In another specific embodiment the herbicidal composition comprises a) a herbicide A, which is glyphosate or an agriculturally acceptable salt thereof,

b) a herbicide B which is saflufenacil or an agriculturally salt thereof, and
c) at least one herbicide C which is an imidazolinone or an agriculturally acceptable salt thereof.

In another specific embodiment the herbicidal composition comprises

a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof;
provided that the herbicidal composition does not contain pyroxasulfone and provided that the herbicidal composition is not a mixture consisting of glyphosate, saflufenacil and imazamox or their agriculturally acceptable salts.

In another specific embodiment the herbicidal composition comprises

a) a herbicide A, which is glyphosate or an agriculturally acceptable salt thereof,
b) a herbicide B which is saflufenacil or an agriculturally salt thereof, and
c) at least one herbicide C which is an imidazolinone selected from the group consisting of imazapyr, imazapic and imazethapyr or an agriculturally acceptable salt thereof;
provided that the herbicidal composition does not contain pyroxasulfone or an agriculturally salt thereof.

In another specific embodiment the herbicidal composition consists of

a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof, provided that the herbicidal composition is not a mixture consisting of glyphosate, saflufenacil and imazamox or their agriculturally acceptable salts.

In another specific embodiment the herbicidal composition consists of

a) a herbicide A, which is glyphosate or an agriculturally acceptable salt thereof,
b) a herbicide B which is saflufenacil or an agriculturally salt thereof, and
c) at least one herbicide C which is selected from the group consisting of imazapyr, imazapic and imazethapyr or their agriculturally acceptable salts.

In another specific embodiment the herbicidal composition consists of

a) a herbicide A, which is glyphosate or an agriculturally acceptable salt thereof,
b) a herbicide B which is saflufenacil or an agriculturally salt thereof, and
c) at least one herbicide C which is selected from the group imazapyr and imazapic or their agriculturally acceptable salts.

In another specific embodiment the herbicidal composition consists of

a) a herbicide A which is glyphosate or an agriculturally acceptable salt thereof,
b) a herbicide B which is saflufenacil or an agriculturally acceptable salt thereof.
c) at least one herbicide C which is selected from the group consisting of imazapyr, imazapic, and imazethapyr or their agriculturally acceptable salts.

In another specific embodiment the herbicidal composition comprises

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts.

In another specific embodiment the herbicidal composition comprises

a) a herbicide A which is glyphosate or an agriculturally acceptable salt thereof,
b) a herbicide B which is saflufenacil or an agriculturally acceptable salt thereof, and
c) herbicides C which are a combination of imazapyr and imazapic or their agriculturally acceptable salts.

2-[(RS)-4-isopropyl-4-methyl-5-oxo-2-imidazolin-2-yl]nicotinic acid (common name: imazapyr, formula III) is an active compound from the group of imidazolinone herbicides, which are known e.g. from Shaner, D. L. O'Conner, S. L, The Imidazolinone Herbicides, CRC Press Inc., Boca Raton, Fla. 1991 and also from The Compendium of Pesticide Common Names http://www.alanwood.net/pesticides.

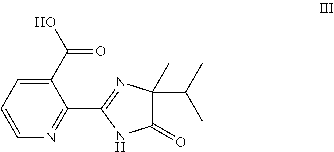 [SMILES: CC(C)C1(C)N=C(c2ncccc2C(=O)O)NC1=O]

2-[(RS)-4-isopropyl-4-methyl-5-oxo-2-imidazolin-2-yl]-5-methylnicotinic acid; common name: imazapic; formula IV) is an active compound from the group of imidazolinone herbicides, which are known e.g. from Shaner, D. L. O'Conner, S. L, The Imidazolinone Herbicides, CRC Press Inc., Boca Raton, Fla. 1991 and also from The Compendium of Pesticide Common Names http://www.alanwood.net/pesticides.

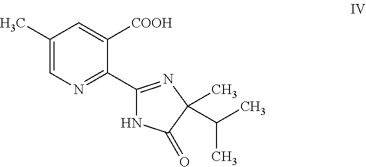 [SMILES: Cc1cnc(C2=NC(C)(C(C)C)C(=O)N2)c(C(=O)O)c1]

In the compositions of the present invention, imazapic and imazapyr are present in a weight ratio preferably in the range from 100:1 to 1:100, in particular in the range from 10:1 to 1:10, more preferably from 5:1 to 1:5 even more preferable from 5:1 to 2:1 (e.g. 3:1).

The herbicidal composition of the invention may further comprise cyclohexanediones such as alloxydim, butroxydim, clethodim, cloproxydim, cycloxydim, profoxydim, sethoxydim, tepraloxydim and tralkoxydim.

The herbicidal composition of the invention may further comprise sulfonylureas, such as chlorsulfuron, metsulfuron, sulfometuron, chlorimuron, trifensulfuron, tribenuron, bensulfuron methyl, nicosulfuron, ethametsulfuron, rimsulfuron, triflusulfuron, triasulfuron, primisulfuron, cinisulfuron, amidosulfuron, flazasulfuron, imazosulfuron, pyrazosulfuron, halo sulfuron, azimsulfuron, cyclosulfuron, chinosulfuron, ethoxysulfuron, flazasulfuron, flupyrsulfuron, foramsulfuron, iodosulfuron, oxasulfuron, mesosulfuron, prosulfuron, sulfosulfuron, trifloxysulfuron, tritosulfuron and their esters and salts such as metsulfuron methyl, sulfometuron methyl, chlorimuron ethyl, trifensulfuron methyl, tribenuron methyl, bensulfuron methyl, ethametsulfuron methyl, triflusulfuron methyl, primisulfuron methyl, pyrazosulfuron ethyl, flupyrsulfuron methyl.

The herbicidal composition of the invention may further comprise triazolopyrimidine herbicides like cloransulam, diclosulam, florasulam, flumetsulam, metosulam, penoxsulam and their esters and salts.

The herbicidal composition of the invention may further comprise sulfonylaminocarbonyltriazolinone like flucarbazone and propoxycarbazone and their esters and salts.

The herbicidal composition of the invention may further comprise phenylpyrazole herbicides such as fluazolate, nipyraclofen, pinoxaden and pyraflufen and their esters and salts.

The herbicidal composition of the invention may further comprise aryloxyphenoxypropionates such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, kuicaoxi, metamifop, propaquizafop, quizalofop, quizalofop-P, trifop and their esters and salts e.g. clodinafop-propargyl, cyhalofop-butyl, diclofop-methyl, fenoxaprop-P-ethyl, fluazifop-P-butyl, haloxyfop-R-methyl and quizalofop-P-ethyl.

Preferably, the herbicidal composition of the invention may further comprises a least one cyclohexanedione. More preferably, the herbicidal composition of the invention may further comprise a least one cyclohexanedione selected from the group consisting of clethodim, and/or tepraloxydim. Even more preferably, the herbicidal composition of the invention may further comprise clethodim.

The compositions of the invention may also comprise one or more safeners. Safeners, also termed as herbicide safeners are organic compounds which in some cases lead to better crop plant compatibility when applied jointly with specifically acting herbicides. Some safeners are themselves herbicidally active. In these cases, the safeners act as antidote or antagonist in the crop plants and thus reduce or even prevent damage to the crop plants. However, in the compositions of the present invention, safeners are generally not required. Therefore, one embodiment of the invention relates to compositions which contain no safener or virtually no safener (i.e. less than 1% by weight, based on the total amount of herbicide A, herbicide B and the at least one herbicide C [total amount of herbicide C], if present).

Suitable safeners, which can be used in the compositions according to the present invention are known in the art, e.g. from The Compendium of Pesticide Common Names (http://www.alanwood.net/pesticides/); Farm Chemicals Handbook 2000 Vol. 86, Meister Publishing Company, 2000; B. Hock, C. Fedtke, R. R. Schmidt, Herbizide, Georg Thieme Verlag, Stuttgart 1995; W. H. Ahrens, Herbicide Handbook, 7th Edition, Weed Science Society of America, 1994; and K. K. Hatzios, Herbicide Handbook, Supplement to 7th Edition, Weed Science Society of America, 1998.

Safeners include benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloracetyl)-1,3-oxazolidine, 4-(dichloroacetyl)-1-oxa-4-azaspiro[4.5]decane and oxabetrinil, as well as thereof agriculturally acceptable salts and, provided they have a carboxyl group, their agriculturally acceptable derivatives. 2,2,5-Trimethyl-3-(dichloroacetyl)-1,3-oxazolidine [CAS No. 52836-31-4] is also known under the name R-29148.4-(Dichloroacetyl)-1-oxa-4-azaspiro[4.5]decane [CAS No. 71526-07-03] is also known under the names AD-67 and MON 4660.

As safener, the compositions according to the invention particularly preferably comprise at least one of the compounds selected from the group consisting of benoxacor, cloquintocet, cyprosulfamide, dichlormid, fenchlorazole, fenclorim, fluxofenim, furilazole, isoxadifen, mefenpyr, naphthalic anhydride, 2,2,5-trimethyl-3-(dichloroacetyl)-1,3-oxazolidine, and 4-(dichloroacetyl)-1-oxa-4-azaspiro[4.5]decane and oxabetrinil; and the agriculturally acceptable salt thereof and, in the case of compounds having a COOH group, an agriculturally acceptable derivative as defined above.

A preferred embodiment of the invention relates to compositions which contain no safener or virtually no safener (i.e. less than 1% by weight, based on the total amount of herbicide A, the at least one herbicide C [total amount of herbicide C], if present).

The compositions of the present invention are suitable for controlling herbicide resistant monocotyledonous plants or dicotyledonous plants.

Thus, the compositions of the present invention are suitable for controlling herbicide resistant monocotyledonous plants, for example monocotyledonous weeds or monocotyledonous volunteer crops.

The compositions of the present invention are also suitable for controlling herbicide resistant dicotyledonous plants, for example dicotyledonous weeds or dicotyledonous volunteer crops.

Further, the compositions of the present invention are suitable for controlling glyphosate resistant monocotyledonous or dicotyledonous plants.

Thus, the compositions of the present invention are particularly suitable for controlling glyphosate resistant monocotyledonous plants, such as monocotyledonous weeds or monocotyledonous volunteer crops.

Thus, the compositions of the present invention are particularly suitable for controlling herbicide resistant plants, such as herbicide resistant weeds or herbicide resistant volunteer crops except Bidens pinata.

Further, the compositions of the present invention are particularly suitable for controlling glyphosate resistant dicotyledonous plants, such as dicotyledonous weeds or dicotyledonous volunteer crops.

The term volunteer crop refers to undesired plants growing adventitiously in a subsequent rotational crop or that has been introduced to the field through equipment, irrigation, wind or other. Dicotyledonous volunteer crops may be for example sunflower, sugarbeet, potato, cotton, brassica crops, such as oilseed rape, canola, mustard, cabbage and turnip, alfalfa, soybean, peanut, pea, bean, lentil, green gram, black gram, cluster bean, fenugreek, other pulse or leguminous crops, or crops which are tolerant to herbicides such as dicamba, 2,4-dichlorophenoxyethanoic acid, ACCase inhibitors, HPPD inhibitors and/or tolerant to sulfonylurea such as STS soybean and/or tolerant to the action of glyphosate such as RoundupReady® crops and/or tolerant to glufosinate such as LibertyLink® crops and/or tolerant to the action of acetohydroxyacid synthase inhibiting herbicides (e.g. imidazolinones), such as for example Clearfield® lentil, Clearfield® oilseed rape or canola, Cultivance® soybean and/or Clearfield® sunflower. For successful combating the volunteer crop, the volunteer crop must be susceptible to at least one of the herbicides of the composition of the invention.

In particular, the compositions of the present invention are suitable for controlling herbicide resistant, in particular glyphosate resistant volunteer crops soybean, cotton, canola, alfalfa, sugarbeet and sunflower.

The compositions of the present invention are suitable for controlling herbicide resistant dicotyledonous weeds.

In particular the compositions of the present invention are suitable for controlling glyphosate resistant weeds, including monocotyledonous weeds, in particular annual and perennial weeds such as Brachiaria species such as Brachiaria plantaginea, Cenchurs species such as Cenchurs echinatus, Chlorys species such as Chlorys elata, Chlorys polydactyla and Chlorys gayana, Digitaria species such as Digitaria insularis, Digitaria horizontalis, Digitaria ciliaris Echinochloa species such as Echinochloa colon, Lolium species such as Lolium rigidum, Lolium perenne ssp. multillorum, Eleusine species such as Eleusine indica, Sorghum species such as Sorghum halepense and the like.

The compositions of the present invention are also suitable for controlling a large number of dicotyledonous weeds, in particular broad leaf weeds including Amaranthus species, Conyza species such as Conyza bonariensis, Conyza canadensis and Conyza sumatrensis Chenopodium species such as Chenopodium album, Kochia species such as Kochia scoparia, Commelina species such as Commelina communis and Commelina benghalensis, Convolvulus species such as Convolvulus arvensis, Ambrosia species such as Ambrosia artemisiifolia, Amaranthus species such as Amaranthus tuberculatus, Abutilon species such as Abutilon theophrasti, Lotus species such as Lotus corniculatus, Dicliptera species such as Dicliptera chinensis, Plantago species such as Plantago lanceolata, Euphorbia species such as Euphorbia heterophylla, Raphanus species such as Raphanus raphanistrum, Ipomoea species such as Ipomoea grandifolia, Setaria species, Spermacoce species such as Spermacoce latifólia, Tridax species such as Tridax procumbens, Richardia species such as Richardia brasiliensis, Borreria species such as Borreria verticilata, Lolium species such as Lolium multiflorum, Bidens species such as Bidens pilosa and the like.

In one embodiment the compositions of the present invention is used for controlling herbicide resistant volunteer crops. In a specific embodiment, the composition of the present invention is used for controlling herbicide resistant dicotyledonous volunteer crops, preferably herbicide resistant soybean. In a more specific embodiment, the composition of the present invention is used for controlling acetohydroxyacid synthase inhibitor resistant soybean.

In a further specific embodiment, the composition of the present invention is used for controlling herbicide resistant monocotylendonous volunteer crops, preferably herbicide resistant corn. In a more specific embodiment, the composition of the present invention is used for controlling acetohydroxyacid synthase inhibitor resistant dicotyledonous soybean. In a more specific embodiment, the composition of the present invention is used for controlling glyphosate resistant soybean.

In one embodiment the compositions of the present invention is used for controlling herbicide resistant dicotyledonous weeds except Bidens species. In another embodiment, the compositions of the present invention are used for controlling herbicide resistant dicotyledonous weeds except Bidens pinata.

In particular the compositions of the present invention are suitable for controlling herbicide resistant, in particular glyphosate resistant Conyza species, such as Conyza bonariensis or Conyza sumatrensis and/or herbicide resistant, in particular glyphosate resistant, Digitaria species such as Digitaria insularis.

The compositions according to the present invention are suitable for combating/controlling common harmful dicotyledonous plants, in particular glyphosate resistant dicotyledonous plants and/or glyphosate resistant monocotyledonous plants in useful plants (i.e. in crops).

The compositions of the present invention are in particular suitable for combating/controlling undesired vegetation in wheat, barley, rye, triticale, durum, rice, corn, sugarcane, sorghum, peanut, sunflower, sugarbeet, potato, cotton, brassica crops, such as oilseed rape, canola, mustard, cabbage and turnip, alfalfa, soybean, peanut, pea, bean, lentil, green gram, black gram, cluster bean, fenugreek, other pulse or leguminous crops, or crops which are tolerant to herbicides such as dicamba, 2,4-dichlorophenoxyethanoic acid, ACCase inhibitors, HPPD inhibitors and/or tolerant to sulfonylurea such as STS soybean and/or tolerant to the action of acetohydroxyacid synthase inhibiting herbicides (e.g. imidazolinones), such as for example Clearfield® wheat, Clearfield® barley, Clearfield® corn, Clearfield® lentil, Clearfield® oilseed rape or canola, Clearfield® rice, Cultivance® soybean and/or Clearfield® sunflower or crops which are tolerant to the action of glyphosate such as RoundupReady® and/or tolerant to the action of glufosinate such as LibertyLink®.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, weeds or volunteer crops or their habitat in crop plants.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, weeds or volunteer crops or their habitat in crop plants.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, and imazethapyr or their agriculturally acceptable salts,
to act on herbicide resistant, in particular glyphosate resistant, weeds or volunteer crops or their habitat in crop plants.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, weeds or volunteer crops or their habitat in crop plants.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, weeds or volunteer crops or their habitat in crop plants.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, weeds or volunteer crops or their habitat in soybean.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, weeds or volunteer crops or their habitat in soybean.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, and imazethapyr or their agriculturally acceptable salts,
to act on herbicide resistant, in particular glyphosate resistant, weeds or volunteer crops or their habitat in soybean.

A specific embodiment of the invention is directed to the method of controlling herbicide resistant, in particular glyphosate resistant, weeds or volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, weeds or volunteer crops or their habitat in soybean.

A specific embodiment of the invention is directed to the method of controlling herbicide resistant, in particular glyphosate resistant, weeds or volunteer crops weeds which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, weeds or volunteer crops or their habitat in soybean.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, monocotyledonous weeds or monocotyledonous volunteer crops or their habitat in soybean.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, monocotyledonous weeds or monocotyledonous volunteer crops or their habitat in crop plants.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, and imazethapyr or their agriculturally acceptable salts,
to act on herbicide resistant, in particular glyphosate resistant, monocotyledonous weeds or monocotyledonous volunteer crops or their habitat in crop plants.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, monocotyledonous weeds or monocotyledonous volunteer crops or their habitat in crop plants.

A specific embodiment of the invention is directed to the method of controlling herbicide resistant, in particular glyphosate resistant, monocotyledonous weeds or monocotyledonous volunteer crops weeds which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, monocotyledonous weeds or monocotyledonous volunteer crops or their habitat in crop plants.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, monocotyledonous weeds or monocotyledonous volunteer crops or their habitat in soybean.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, and imazethapyr or their agriculturally acceptable salts,
to act on herbicide resistant, in particular glyphosate resistant, monocotyledonous weeds or monocotyledonous volunteer crops or their habitat in soybean.

A specific embodiment of the invention is directed to the method of controlling herbicide resistant, in particular glyphosate resistant, monocotyledonous weeds or monocotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, monocotyledonous weeds or monocotyledonous volunteer crops or their habitat in soybean.

A specific embodiment of the invention is directed to the method of controlling herbicide resistant, in particular glyphosate resistant, monocotyledonous weeds or monocotyledonous volunteer crops weeds which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, monocotyledonous weeds or monocotyledonous volunteer crops or their habitat in soybean.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, Digitaria species or their habitat in crop plants.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, Digitaria species or their habitat in crop plants.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, Digitaria species or their habitat in crop plants.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, Digitaria species or their habitat in crop plants.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, Digitaria species or their habitat in soybean.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, Digitaria species or their habitat in soybean.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, and imazethapyr or their agriculturally acceptable salts,
to act on herbicide resistant, in particular glyphosate resistant, Digitaria species or their habitat in soybean.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, Digitaria species or their habitat in soybean.

A specific embodiment of the invention is directed to the method of controlling herbicide resistant, in particular glyphosate resistant, Digitaria species which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, Digitaria species or their habitat in soybean.

A specific embodiment of the invention is directed to the method of controlling herbicide resistant, in particular glyphosate resistant, dicotyledonous weeds or dicotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, dicotyledonous weeds or dicotyledonous volunteer crops or their habitat.

A specific embodiment of the invention is directed to the method of controlling herbicide resistant, in particular glyphosate resistant, dicotyledonous weeds or dicotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, dicotyledonous weeds or dicotyledonous volunteer crops or their habitat.

A specific embodiment of the invention is directed to the method of controlling herbicide resistant, in particular glyphosate resistant, dicotyledonous weeds or dicotyledonous volunteer crops which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, dicotyledonous weeds or dicotyledonous volunteer crops or their habitat.

A specific embodiment of the invention is directed to the method of controlling herbicide resistant, in particular glyphosate resistant, dicotyledonous weeds or dicotyledonous volunteer crops weeds which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, dicotyledonous weeds or dicotyledonous volunteer crops or their habitat.

A specific embodiment of the invention is directed to the method of controlling herbicide resistant, in particular glyphosate resistant, Conyza species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is an imidazolinone or an agriculturally acceptable salt thereof,
to act on herbicide resistant, in particular glyphosate resistant, Conyza species or their habitat.

A specific embodiment of the invention is directed to the method of controlling herbicide resistant, in particular glyphosate resistant, Conyza species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr, imazapic, imazamox and imazethapyr or their agriculturally acceptable salts,
to act on herbicide resistant, in particular glyphosate resistant, Conyza species or their habitat.

A specific embodiment of the invention is directed to the method of controlling herbicide resistant, in particular glyphosate resistant, Conyza species which comprises allowing the composition comprising

a) a herbicide A which is glyphosate or an agriculturally acceptable salt thereof,
b) a herbicide B which is saflufenacil or an agriculturally acceptable salt thereof, and
c) at least one herbicide C which is selected from the group consisting of imazapyr and imazapic or their agriculturally acceptable salts,
to act on herbicide resistant, in particular glyphosate resistant, Conyza species or their habitat.

A specific embodiment of the invention is directed to the method of controlling herbicide resistant, in particular glyphosate resistant, Conyza species which comprises allowing the composition comprising

a) a herbicide A which is glyphosate or an agriculturally acceptable salt thereof,
b) a herbicide B which is saflufenacil or an agriculturally acceptable salt thereof, and
c) herbicides C which are combination of imazapyr and imazapic or their agriculturally acceptable salts,
to act on herbicide resistant, in particular glyphosate resistant, Conyza species or their habitat.

The compositions of the present invention are most suitable for combating/controlling undesired vegetation in soybean, peanut, pea, bean, lentil, green gram, black gram, cluster bean, fenugreek, other pulse or leguminous crops, preferably soybean (Glycine max), including varieties such as Cultivance® soybean and RR soybean.

If not stated otherwise, the compositions of the invention are suitable for application in any variety of the aforementioned crop plants.

The compositions according to the invention can also be used in crop plants which are tolerant to one or more herbicides owing to genetic engineering or breeding, which are resistant to one or more pathogens such as plant pathogenous fungi to genetic engineering or breeding, or which are resistant to attack by insects owing to genetic engineering or breeding. Suitable are for example pulse or leguminous crop plants, preferably soybean, peanut, pea, bean, green gram, black gram, cluster bean, fenugreek, or lentil which are tolerant to herbicidal AHAS inhibitors, such as, for example imazethapyr, or pulse or leguminous crop plants, preferably soybean, peanut, pea, bean, green gram, black gram, cluster bean, fenugreek, or lentil which, owing to introduction of the gene for Bt toxin by genetic modification, are resistant to attack by certain insects. Most suitable are soybeans which are tolerant to herbicidal AHAS inhibitors, such as, for example imazethapyr or soybean plants which, owing to introduction of the gene for Bt toxin by genetic modification, are resistant to attack by certain insects.

The compositions of the present invention can be applied in conventional manner by using techniques as skilled person is familiar with. Suitable techniques include spraying, atomizing, dusting, spreading or watering. The type of application depends on the intended purpose in a well known manner; in any case, they should ensure the finest possible distribution of the active ingredients according to the invention.

The compositions can be applied pre- or post-emergence, i.e. before, during and/or after emergence of the undesirable plants. Preferably, the compositions are applied post-emergence, in particular after the emergence of the undesirable plants.

When the compositions are used in crops, they can be applied before or after seeding and before or after the emergence of the crop plants. Preferably the compositions of the invention are applied before seeding of the crop plants. In particular, the compositions of the invention are applied at least 4 days before crop seeding. Preferably the compositions of the invention are applied 50 to 1 days before crop seeding of the crop such as 40 to 3 days, such as 30 to 5 days before crop seeding.

The compositions of the invention are applied at least one time, for example two times before seeding of the crop plants. Preferably the compositions of the invention are applied repeatedly. That means that the composition is applied for two times, for three times or more. More preferably the compositions of the invention are applied for two times, wherein a time interval of 30 to 20 days, such as 25 days is between the two time points of applying the composition of the invention. For example the first application may be at 50 to 15 days, such as 40 to 20 days, such as 35 to 25 days (e.g. 30 days) before crop seeding. The second application may be 10 to 1 days, such as 8 to 3 days (e.g. 5 days) before crop seeding.

In any case the components of herbicide A, herbicide B and the at least one herbicide C can be applied simultaneously or in succession.

The compositions are applied to the plants mainly by spraying, in particular foliar spraying. Application can be carried out by customary spraying techniques using, for example, water as carrier and spray liquor rates of from about 10 to 2000 I/ha or 50 to 1000 I/ha (for example from 100 to 500 I/ha). Application of the herbicidal compositions by the low-volume and the ultra-low-volume method is possible, as is their application in the form of microgranules.

In the case of a post-emergence treatment of the plants, the herbicidal mixtures or compositions according to the invention are preferably applied by foliar application. Application may be effected, for example, by usual spraying techniques with water as the carrier, using amounts of spray mixture of approx. 20 to 1000 I/ha.

The required application rate of the composition of the pure active compounds, i.e. of herbicide A, herbicide B and the at least one herbicide C and optionally safener depends on the density of the undesired vegetation, on the development stage of the plants, on the climatic conditions of the location where the composition is used and on the application method. In general, the application rate of the composition (total amount of herbicide A, herbicide B, the at least one herbicide C, optional further actives) is from 1 to 5,000 g/ha, preferably from 500 to 2,000 g/ha of active substance.

The required application rates of the glyphosate are generally in the range from 1 g/ha to 5,000 g/ha and preferably in the range from 5 g/ha to 3,000 g/ha or from 10 g/ha to 1,500 g/ha of active substance.

The required application rates of saflufenacil are generally in the range from 1 g/ha to 200 g/ha and preferably in the range from 5 g/ha to 150 g/ha or from 10 g/ha to 100 g/ha of active substance.

The required application rates of an imidazolinone herbicide are generally in the range from 1 g/ha to 200 g/ha and preferably in the range from 5 g/ha to 150 g/ha or from 10 g/ha to 100 g/ha of active substance.

The required application rates of imazapic are generally in the range from 1 g/ha to 200 g/ha and preferably in the range from 5 g/ha to 150 g/ha or from 10 g/ha to 100 g/ha of active substance.

The required application rates of imazapyr are generally in the range from 1 g/ha to 200 g/ha and preferably in the range from 5 g/ha to 150 g/ha or from 10 g/ha to 100 g/ha of active substance.

The required application rates of the at least one herbicide C (total amount of herbicide C) e.g. the total amount of the combination of imazapic and imazapyr are generally in the range from 1 g/ha to 500 g/ha and preferably in the range from 25 g/ha to 300 g/ha or from 50 g/ha to 150 g/ha, such as about 100 g/ha.

The required application rates of the safener, if applied, are generally in the range from 1 g/ha to 2,000 g/ha and preferably in the range from 2 g/ha to 2,000 g/ha or from 5 g/ha to 2,000 g/ha of active substance.

The weight ratio of herbicide A to herbicide B is from 1:1 to 100:1, preferably from 3:1 to 60:1, more preferably from 3:1 to 50:1, and/or the ratio of herbicide A to herbicide C is from 1:1 to 100:1, preferably from 2:1 to 50:1, and/or the ratio of herbicide B to herbicide C is 50:1 to 1:50, preferably 10:1 to 1:20, more preferably from 3:1 to 1:10.

The above mentioned application rates of herbicides indicate the amount of active agent without auxiliaries such as carrier material or surfactants.

The above mentioned application rates of herbicides and safeners are also disclosed in any combination.

If not stated otherwise, the compositions of these embodiments are suitable for application in any variety of the aforementioned crop plants.

The present invention also relates to formulations of the compositions according to the present invention. The formulations contain, besides the composition, at least one organic or inorganic carrier material. The formulations may also contain, if desired, one or more surfactants and, if desired, one or more further auxiliaries customary for crop protection compositions.

The formulation may be in the form of a single package formulation containing herbicide A, herbicide B and the at least one herbicide C together with liquid and/or solid carrier materials, and, if desired, one or more surfactants and, if desired, one or more further auxiliaries customary for crop protection compositions. The formulation may be in the form of a several package formulation, wherein one package contains a formulation of the herbicide A, one package contains a formulation of the herbicide B and one package contains a formulation of the at least one herbicide C and wherein all formulations contain at least one carrier material, if desired, one or more surfactants and, if desired, one or more further auxiliaries customary for crop protection compositions. In the case of the several packages formulations the formulation containing the herbicide A, the formulation containing the herbicide B and the formulation containing the at least one herbicide C are mixed prior to application. Preferably the mixing is performed as a tank mix, i.e. the formulations are mixed immediately prior or upon dilution with water.

In the formulation of the present invention the active ingredients, i.e. herbicide A, herbicide B and the at least one herbicide C and optional further actives are present in suspended, emulsified or dissolved form. The formulation according to the invention can be in the form of aqueous solutions, powders, suspensions, also highly-concentrated aqueous, oily or other suspensions or dispersions, aqueous emulsions, aqueous microemulsions, aqueous suspoemulsions, oil dispersions, pastes, dusts, materials for spreading or granules.

Depending on the formulation type, they comprise one or more liquid or solid carriers, if appropriate surfactants (such as dispersants, protective colloids, emulsifiers, wetting agents and tackifiers), and if appropriate further auxiliaries which are customary for formulating crop protection products. The person skilled in the art is sufficiently familiar with the recipes for such formulations. Further auxiliaries include e.g. organic and inorganic thickeners, bactericides, antifreeze agents, antifoams, colorants and, for seed formulations, adhesives.

Suitable carriers include liquid and solid carriers. Liquid carriers include e.g. non-aqueous solvents such as cyclic and aromatic hydrocarbons, e.g. paraffins, tetrahydro-naphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof. Solid carriers include e.g. mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers™-types, Borregaard), phenolsulfonic acids, naphthalenesulfonic acids (Morwet types, Akzo Nobel) and dibutylnaphthalenesulfonic acid (Nekal® types, BASF SE), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol® types Clariant), polycarboxylates (BASF SE, Sokalan® types), polyalkoxylates, polyvinylamine (BASF SE, Lupamine® types), polyethyleneimine (BASF SE, Lupasol® types), polyvinylpyrrolidone and copolymers thereof. A suitable non-ionic wetting agent is for example DASH® (BASF).

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R.T. Vanderbilt), and also organic and inorganic sheet minerals, such as Attaclay® (from Engelhardt).

Examples of antifoams are silicone emulsions (such as, for example, Silikon®• SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on diclorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide® MBS from Thor Chemie).

Examples of antifreeze agents are ethylene glycol, propylene glycol, urea or glycerol.

Examples of colorants are both sparingly water-soluble pigments and water-soluble dyes. Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives are polyvinylpyrrolidone, polyvinyl acetate, polyvinyl alcohol and tylose.

To prepare emulsions, pastes or oil dispersions, the active the components, as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Powders, materials for spreading and dusts can be prepared by mixing or concomitant grinding of herbicide A, herbicide B, the at least one herbicide C and optionally safener with a solid carrier.

Granules, e.g. coated granules, impregnated granules and homogeneous granules, can be prepared by binding the active ingredients to solid carriers.

The formulations of the invention comprise a herbicidally effective amount of the composition of the present invention. The concentrations of the active the active ingredients in the formulations can be varied within wide ranges. In general, the formulations comprise from 1 to 98% by weight, preferably 10 to 60% by weight, of active ingredients (sum of herbicide A, herbicide B and the at least one herbicide C [total amount of herbicide C] and optionally further active compounds). The active ingredients are employed in a purity of from 90% to 100%, preferably 95% to 100% (according to NMR spectrum).

The herbicide A, herbicide B and the at least one herbicide C as well as the compositions according to the invention can, for example, be formulated as follows:

1. Products for Dilution with Water

### A Water-Soluble Concentrates

10 parts by weight of active compound (or composition) are dissolved in 90 parts by weight of water or a water-soluble solvent. As an alternative, wetters or other adjuvants are added. The active compound dissolves upon dilution with water. This gives a formulation with an active compound content of 10% by weight.

### B Dispersible Concentrates

20 parts by weight of active compound (or composition) are dissolved in 70 parts by weight of cyclohexanone with addition of 10 parts by weight of a dispersant, for example polyvinylpyrrolidone. Dilution with water gives a dispersion. The active compound content is 20% by weight.

### C Emulsifiable Concentrates

15 parts by weight of active compound (or composition) are dissolved in 75 parts by weight of an organic solvent (eg. alkylaromatics) with addition of calcium dodecyl-benzenesulfonate and castor oil ethoxylate (in each case 5 parts by weight). Dilution with water gives an emulsion. The formulation has an active compound content of 15% by weight.

### D Emulsions

25 parts by weight of active compound (or composition) are dissolved in 35 parts by weight of an organic solvent (eg. alkylaromatics) with addition of calcium dodecyl-benzenesulfonate and castor oil ethoxylate (in each case 5 parts by weight). This mixture is introduced into 30 parts by weight of water by means of an emulsifier (Ultraturrax) and made into a homogeneous emulsion. Dilution with water gives an emulsion. The formulation has an active compound content of 25% by weight.

### E Suspensions

In an agitated ball mill, 20 parts by weight of active compound (or composition) are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

### F Water-Dispersible Granules and Water-Soluble Granules

50 parts by weight of active compound (or composition) are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

### G Water-Dispersible Powders and Water-Soluble Powders

75 parts by weight of active compound (or composition) are ground in a rotor-stator mill with addition of 25 parts by weight of dispersants, wetters and silica gel. Dilution with water gives a stable dispersion or solution of the active compound. The active compound content of the formulation is 75% by weight.

### H Gel Formulations

In a ball mill, 20 parts by weight of active compound (or composition), 10 parts by weight of dispersant, 1 part by weight of gelling agent and 70 parts by weight of water or of an organic solvent are mixed to give a fine suspension. Dilution with water gives a stable suspension with active compound content of 20% by weight.

### 2. Products to be Applied Undiluted

### I Dusts

5 parts by weight of active compound (or composition) are ground finely and mixed intimately with 95 parts by weight of finely divided kaolin. This gives a dusting powder with an active compound content of 5% by weight.

### J Granules (GR, FG, GG, MG)

0.5 parts by weight of active compound (or composition) are ground finely and associated with 99.5 parts by weight of carriers. Current methods here are extrusion, spray-drying or the fluidized bed. This gives granules to be applied undiluted with an active compound content of 0.5% by weight.

K ULV solutions (UL)

10 parts by weight of active compound (or composition) are dissolved in 90 parts by weight of an organic solvent, for example xylene. This gives a product to be applied undiluted with an active compound content of 10% by weight.

Aqueous use forms can be prepared from emulsion concentrates, suspensions, pastes, wettable powders or water-dispersible granules by adding water.

It may furthermore be beneficial to apply the compositions of the invention alone or in combination with other herbicides, or else in the form of a mixture with other crop protection agents, for example together with agents for controlling pests or phytopathogenic fungi or bacteria. Also of interest is the miscibility with mineral salt solutions, which are employed for treating nutritional and trace element deficiencies. Other additives such as non-phytotoxic oils and oil concentrates may also be added.

In specific embodiments the herbicide A, herbicide B and herbicide C are applied in synergistically effective amounts.

Therefore the term “synergistically effective amount” means that herbicide A, herbicide B and herbicide C are applied in an amount that achieves an synergistic effect.

It is also understood that that the definition “synergistically effective amount” can be applied accordingly to herbicidal composition comprising the herbicide A, herbicide B and herbicide C and a further herbicide.

In some embodiments, the synergistic effect occurs at least 7 days, 14 days, 21 days, 28 days, 35 days and 42 days after application.

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 21-22):

$$E = X + Y - \frac{XY}{100}$$

When the observed combined control effect is greater than the expected (calculated) combined control effect (E), then the combined effect is synergistic. The synergistic effect may also be present when the observed combined control effect is equal to the expected (calculates) combined control effect, especially when control values over 90 are calculated.

The following tests demonstrate the control efficacy of compounds, mixtures or compositions of this invention on specific weeds. However, the weed control afforded by the compounds, mixtures or compositions is not limited to these species.The analysis of synergism or antagonism between the mixtures or compositions was determined using Colby's equation.

Analogously, the Colby's equation can be used to determine synergism of 3-way and higher mixtures:

$$E = X + Y + Z + \frac{XYZ}{10000} - [ \frac{( XY ) + ( XZ ) + ( YZ )}{100} ]$$

### EXAMPLES

### Example 1

The experiment was carried out in Brazil, at altitude of 552 meters, from Nov. 2, 2012 to Mar. 1, 2013.

A soil sample from the experimental site was analyzed and provided pHH₂O 5.5; 3.8 cmol_{c} H+Al⁺³/dm³; 3.6 cmol_{c}/dm³ Ca⁺²; 1.0 cmol_{c}/dm³ Mg⁺²; 0.49 cmol_{c}/dm³ K+; 8.0 mg/dm³ P; 29.0 g/dm³ OC; 12.70% coarse sand; 3.20% fine sand; 16.80% silt and 67.30% clay.

For all herbicide applications, the applications were made using a backpack sprayer that was pressurized by CO₂ with five flat fan nozzles XR110.02 at 200 KPa, which caused the application volume to reach 200 L ha⁻¹.

In Table 1 all details related to mode of application of herbicides, and climatic conditions during herbicide application are listed. Treatments were composed by different programs of herbicides or combinations of herbicides applications, as described in Table 2.

Crop sowing was carried out under a no-tillage system, by distributing 16 seeds per meter of a Cultivance® soybean variety (BRZ 09-1882) in all treatments with Onduty® and also 16 seeds m⁻¹ of a second soybean cultivar (BMX Potëncia RR) in the remaining treatments. Immediately before sowing, the seeds of both cultivars were treated with the insecticide Standak® Top (200 mL per ha) and were inoculated with Biomax (300 mL per 100 kg seed). Crop fertilization was performed with 200 kg ha⁻¹ of a commercial N—P—K formulation (00-18-18).

TABLE 1
Descriptive details concerned to herbicide applications performed during this experiment.

| | Applications | | | |
|---|---|---|---|---|
| | A | B | C | D |
| Modality | Post-emergence of weeds - | Post-emergence of | Immediately after | Post- |
| | desiccation 30 days | weeds - desiccation 5 | crop sowing | emergence |
| | before soybean sowing | days before soybean | (“plant-and-apply”) | of soybeans |
| | | sowing | | (stage V4) and |
| | | | | weeds |
| Date | 02/11/2012 | 29/11/2012 | 04/12/2012 | 15/01/2013 |
| Period of the | 09:00-10:00 | 09:00-09:30 | 07:25-0:9:30 | 10:00-11:25 |
| day | | | | |
| Air temp. | 24 | 26 | 27 | 23 |
| (° C.) | | | | |
| Air moisture | 65 | 62 | 65 | 68 |
| (%) | | | | |
| Soil | moist | moist | moist | moist |
| Wind speed | 0.5 | 2.3 | 1.8 | 1.4 |
| (km h⁻¹) | | | | |
| Soil cover | 90 to 95% | — | — | — |
| Light | clear sky, no clouds | clear sky, no clouds | clear sky, no | clear sky, no |
| | | | clouds | clouds |
| Weed | Conyza spp. (10 to 20 cm) | — | — | Digitaria |
| infestation | (66 plants m⁻²) and | | | insularis (4 |
| and stage | Digitaria insularis (1 tiller to | | | leaves - 1 tiller) |
| | flowering) (44 plants m⁻²) | | | |

Tables 3 and 4 contain all data concerned to temperature, relative humidity and rainfall and product description (common names, chemical names, chemical groups, mechanisms of action, toxicological classes of herbicides) used in this work.

A randomized blocks experimental design was used, with 10 treatments (7 treatments with Cultivance variety and 3 treatments with BMX Potencia RR variety) and four replications. Experimental plots consisted of seven planting rows, spaced 0.45 m, and 5.0 m of length (20.0 m²). The area used for all evaluations in each parcel was that comprehended within the five central planting rows of each parcel, except 1.0 m from each end.

Weed infestation by the application “A” is described on Table 1. After the first application (application “A”), two evaluations were performed on the effect of treatments on the weeds emerged at that application. For those evaluations, we used as reference the infestation of the untreated controls. These assessments were determined as the percentage of control (visual scale 0-100%, where 0% means no symptoms and 100% total control of weed) at 17 and 25 days after application “A” (DAA-A).

Another evaluation was performed after the second application (five days before soybean sowing, application “B”) to analyze the effect of treatments on the control of remaining emerged flora (Conyzaspp. and D. insularis) at the time of application. For this evaluation, the same visual scale 0-100% was used and weed control efficiency was rated at five days after application “B” (5 DAA-B).

After crop sowing and application “C” (“plant-and-apply”), another set of three weed control evaluations (07, 22 and 42 DAA-C) were also performed, using the same visual rating scale. For the evaluations at 22 and 42 DAA-C, a weed count was also performed. For that, each parcel was randomly sampled (0.5×0.5 m) four times and results were converted to density of emerged plants (plants m⁻²).

One last weed control evaluation and weed count was performed 18 days after application “D” (18 DAA-D).

Regarding the selectivity to soybean, evaluations were performed at 7, 15 and 45 days after emergence (DAE) by EWRC scale 1-9 (EWRC, 1964), where 1 represents no symptom and 9 represents plant death. After termination of the experiment all plants remaining in the experimental area were mechanically destroyed.

Data were subjected to analysis of variance by F test and means were compared by the Scott-Knott test at 5% and 20% probability. Further the coefficient of variation (CV) is indicated.

Control of Digitaria insularis
a) Control D. insularis between application “A” and application “B”.

Data on D. insularis control obtained in two evaluations performed after the first application of herbicides (application “A”) are shown in Table 5. Statistical analysis was calculated at two levels of significance to the usual 5% probability and 20% probability. However, the discussion of weed control in this text analysis is guided on a 20% probability, due to higher discriminatory power and accuracy in significant differences found.

At 25 DAA-A, the levels of control provided by the addition of 150 g ha⁻¹ of Onduty® were higher than other treatments, and provided control of 86.50% when associated with Aramo and 87.50% when associated with Select.

A visual evaluation on the size of the new sprouts at this date (25 DAA-A) revealed that the average new growth in plants from treatment with Onduty®150 g c.p. ha⁻¹ was at most 5 cm regardless of the cyclohexanedione (Aramo or Select);

In this sense, the addition of Onduty® to cyclohexanediones Select and Aramo not only improved the control of D. insularis, but also promoted a substantial suppression of the weed regrowth, which is a very important attribute due to the great ability of this species to regrow.

b) Control D. insularis Between Application “B” and Soybean Sowing (Application “C”—“Plant-and-Apply”).

Table 6 contains results of D. insularis control at the evaluation performed immediately before soybean sowing (5 DAA-B). Again, the best levels of control were observed in those treatments that received in the Application “A” the association of Onduty® at 150 g c.p. ha⁻¹ with any cyclohexanedione or Onduty® at 100 g c.p. ha⁻¹ associated to Select (T2, T5 and T6). A second group of good control was composed by the treatment that associated Onduty® at 100 g c.p. ha⁻¹ to Aramo (T3) and by the treatment with no addition of BAS71400H but with two applications of Select (T10).

c) Control of D. insularis Between Soybean Sowing (Application “C”) and Post-Emergence Application (“D”)

The results of control of D. insularis obtained in three evaluations after application “C” are found in Tables 7 and 8. Based on Table 8, in the first evaluation, 7 DAA-C, again the best controls were observed in the treatments with Onduty® in the application “A”, independent of dose (control 93.00%).

In the following evaluation, 22 DAA-C, the efficiency of treatments that received Onduty® 100 g c.p. ha⁻¹ at application “A” observing reached 82.50% when combined with Aramo and t85.00% when combined with Select.

At 42 DAA-C, timing of the post-emergence application in some treatments, there was another weed control evaluation. Compositions containing Onduty® at 150 g c.p. ha⁻¹ in application “A”, reached 94.00% weed control at the association with Aramo and 90.00% at the association with Select. Associations of Onduty® at 100 g c.p. ha⁻¹ in application “A”, both with Aramo and Select, provided 80.00% weed control efficiency.

Another aspect evaluated was the residual effect on new fluxes of emergence of D. insularis. The results of weed counts are in tables 9 and 10 and results are expressed in terms of density of live plants in each treatment at 22 and 42 DAA-C.

Onduty® provided excellent residual control, allowing reduction between 85 and 90% in the emergence of new plants within the crop cycle. This lower density of plants in treatments with Onduty® leads to a much more comfortable and efficient post-emergence application, what affects positively the final control. The residual control also helps in controlling soil seed bank, which may have positive implications in the management of the area in the long term.

### d) Control of D. Insularis Between Application “D” and Mechanical Crop Destruction.

Results of control of D. insularis after application “D” are in Table 11. The best treatments were those which received Onduty® 150 g c.p. ha⁻¹ in application “A”, despite of the cyclohexanedione (96.00% control with Aramo and 94.50% with Select);

On the same date, 18 DAA-D, a new weed count of emerged plants of D. insularis was done (Table 12). There was a flux of new plants in all treatments, however, in all treatments containing Onduty®, despite of dose and application timing, the densities were always lower, demonstrating some control of this herbicide.

Looking at the overall context of D. insularis control, it seems evident that the combination of Onduty® especially at 150 g c.p. ha⁻¹ applied 30 days before soybean sowing (despite of which cyclohexanedione was used) was highly beneficial in controlling this weed. This gain comes from the combined benefit of delayed regrowth of mature plants and of the reduction in the emergence of new fluxes, due to the residual effect found in all treatments where Onduty® was applied.

### Control of Conyza Spp.

a) Control of Conyza Spp. Between Application “A” and Application “B”.

Data of Conyza spp. control in both evaluations performed after application “A” are shown in

Table 13. At 17 DAA-A, all the associations of herbicides demonstrated good levels of control (83.75 to 94.25%). At 25 DAA-A, control levels remained stable in the treatments containing Onduty®, despite of the dose (control range 82.50 to 85.00%).

b) Conyza Spp. Control Between Application “B” and Soybean Sowing (Application “C”—“Plant-and-Apply”).

Data compiled from results of Conyza spp. control at pre-sowing evaluation (5 DAA-B) is on Table 14.

c) Control of Conyza Spp. Between Soybean Sowing (Application “C”) and Post-Emergence Application (“D”)

The results of control of Conyza spp. obtained in three evaluations after application “C” are found in Table 15.

At 22 DAA-C, the efficiency of the sequential application of Heat associated to Onduty® (despite of the dose) remained above 97.00%,

At the evaluation of 42 DAA-C, treatments with a sequential application of Heat associated to Onduty® reached control levels of 96.75%.

d) Control of Conyza Spp. Between Application “D” and Mechanical Crop Destruction.

Results of control of Conyza spp. after application “D” are in Table 16.

At 18 DAA-D, the best treatments were those that received the sequential application of Heat associated to Onduty®, despite of its dose (control 97.50%);

### Selectivity for Cultivance Soybean

In all three evaluations performed after crop emergence (7, 15 and 45 DAE), no visual injury was found (data not shown), both in Cultivance cv. and in BMX Potencia RR, suggesting that all herbicides and associations were safe for soybeans.

TABLE 2
Treatments, doses and application modalities. All herbicide doses are
expressed as mass or volume per hectare of commercial formulations.

| | | | | Application “C” | Application “D” |
|---|---|---|---|---|---|
| | | Application “A” | Application “B” | (immediately after | (42 days after |
| Treat. | Var. | (30 days before crop sowing) | (5 days before crop sowing) | crop sowing) | crop sowing) |
| 01 | Cultivance | No herbicide (unweeded check | No herbicide | No herbicide | No herbicide |
| | cv. | Cultivance cv.) | | | |
| 02 | | Roundup Original + Heat + | Roundup¹ + Heat + Onduty ® + | — | — |
| | | Onduty ® + Aramo^{1/} | Aramo^{1/} | | |
| | | (3.0 L + 50 g + 150 g + 0.8 L) | (3.0 L + 50 g + 150 g + 0.8 L) | | |
| 03 | | Roundup Original + Heat + | Roundup¹ + Heat + Onduty ® + | — | — |
| | | Onduty + Aramo^{1/} | Aramo^{1/} | | |
| | | (3.0 L + 50 g + 100 g + 0.8 L) | (3.0 L + 50 g + 150 g + 0.8 L) | | |
| 04 | | — | Roundup + Heat + Aramo^{1/} | Onduty ®^{1/} | Aramo² |
| | | | (3.0 L + 50 g + 0.8 L) | (150 g) | (0.5 L) |
| 05 | | Roundup Original + Heat + | Roundup + Heat + Onduty ® + | — | — |
| | | Onduty ® + Select^{1/} | Select^{1/} | | |
| | | (3.0 L + 50 g + 150 g + 0.75 L) | (3.0 L + 50 g + 150 g + 0.75 L) | | |
| 06 | | Roundup Original + Heat + | Roundup + Heat + Onduty ® + | — | — |
| | | Onduty ® + Select^{1/} | Select^{1/} | | |
| | | (3.0 L + 50 g + 100 g + 0.75 L) | (3.0 L + 50 g + 150 g + 0.75 L) | | |
| 07 | | — | Roundup + Heat + Select^{1/} | Onduty ®^{1/} | Select² |
| | | | (3.0 L + 50 g + 0.75 L) | (150 g) | (0.45 L) |
| 08 | X Potencia | No herbicide (unweeded check | No herbicide | No herbicide | No herbicide |
| | RR cv. | BMX Potencia cv.) | | | |
| 09 | | — | Roundup + Heat + Select^{1/} | — | Roundup Ready + |
| | | | (3.0 L + 50 g + 0.75 L) | | Select^{2/} |
| | | | | | (2.0 L + 0.45 L) |
| 10 | | Roundup Original + Heat + | Roundup + Heat + Select^{1/} | — | Roundup Ready + |
| | | Select^{1/} | (3.0 L + 50 g + 0.75 L) | | Select^{2/} |
| | | (3.0 L + 50 g + 0.75 L) | | | (2.0 L + 0.45 L) |

^{1/}Applied with Dash 0.5% v v⁻¹.
^{2/}Applied with Assist 0.5% v v⁻¹.
Roundup Original: 360 g a.e. of glyphosate L⁻¹; Aramo: CE, 200 g L⁻¹ tepraloxydim; Heat, WG, 700 g kg⁻¹ saflufenacil; Onduty ® = WG [525 g imazapic + 175 g de imazayir] kg⁻¹; Select: EC, 240 g L⁻¹ clethodim; Roundup Ready: 480 g a.e. of glyphosate L⁻¹.

TABLE 3
Common names of active ingredients, chemical names, chemical groups, mechanisms
of action and toxicological classes of herbicides in this trial.

| | | | Mechanism | Toxicological |
|---|---|---|---|---|
| Common name | Chemical name | Chemical group | of action | class |
| Glyphosate | N-(phosphonomethyl) | Glycines | EPSPs | Roundup |
| | glycine | | Inhibitor | Original = III |
| | | | | (moderately |
| | | | | hazardous) |
| Saflufenacil | N′-{2-chloro-4-fluoro-5- | Uracil/amides | PPO | Heat ® = to be |
| | [1,2,3,6-tetrahydro-3-methyl- | | inhibitor | determined by |
| | 2,6-dioxo-4- | | | ANVISA |
| | (trifluoromethyl)pyrimidin-1- | | | |
| | yl]benzoyl}-N-isopropyl-N- | | | |
| | methylsulfamide | | | |
| [Imazapic + | (RS)-2-(4-isopropyl-4- | [Imidazolinones + | [ALS | Onduty ® = III |
| imazapyr] | methyl-5-oxo-2-imidazolin-2- | imidazolinones] | inhibitor + | (moderately |
| | yl)-5-methylnicotinic acid + | | ALS | hazardous) |
| | [2-(4-isopropyl-4-methyl-5- | | inhibitor] | |
| | oxo-2-imidazolin-2- | | | |
| | yl)nicotinic acid | | | |
| Tepraloxydim | (EZ)-(RS)-2-{1-[(2E)-3- | Cyclohexanediones | ACCase | Aramo ® = II |
| | chloroallyloxymino] propil}-3- | | inhibitor | (highly |
| | hydroxy-5-perhydropyran-4- | | | hazardous) |
| | ylcyclohex-2-en-1-one | | | |
| Clethodim | (RS)-2-[(E)-1-[(E)-3- | Cyclohexanediones | ACCase | Select 240 |
| | chloroallyloxyimino]propyl]-5- | | inhibitor | EC = I |
| | [2-(ethylthio)propyl]-3- | | | (extremely |
| | hydroxycyclohex-2-en-1-one | | | hazardous) |
| Glyphosate | N-(phosphonomethyl) | Glycines | EPSPs | Roundup |
| | glycine | | Inhibitor | Ready = II |
| | | | | (highly |
| | | | | hazardous) |

TABLE 4
Visual weed control (%) (Digitaria insularis) in two evaluations after application “A”
(30 days before crop sowing) compared at two significance (α) levels (p < 0.05 and p < 0.20).

| Treatments | | % control | | % control | |
|---|---|---|---|---|---|
| (only herbicides in application “A”, | | Digitaria insularis* | | Digitaria insularis** | |
| 30 days before crop sowing) | L or g p.c. ha⁻¹ | 17 DAA-A | 25 DAA-A | 17 DAA-A | 25 DAA-A |
| 01. No herbicide | — | 0.00 b | 0.00 d | 0.00 b | 0.00 e |
| 02. Roundup^{1/} + Heat + Onduty + Aramo^{2/} | 3.0 + 50 + 150 + 0.8 | 51.25 a | 86.50 a | 51.25 a | 86.50 a |
| 03. Roundup^{1/} + Heat + Onduty + Aramo^{2/} | 3.0 + 50 + 100 + 0.8 | 55.00 a | 78.75 b | 55.00 a | 78.75 c |
| 04. — | — | 0.00 b | 0.00 d | 0.00 b | 0.00 e |
| 05. Roundup^{1/} + Heat + Onduty + Select^{2/} | 3.0 + 50 + 150 + 0.75 | 55.00 a | 87.50 a | 55.00 a | 87.50 a |
| 06. Roundup^{1/} + Heat + Onduty + Select^{2/} | 3.0 + 50 + 100 + 0.75 | 53.75 a | 81.25 b | 53.75 a | 81.25 b |
| 07. — | — | 0.00 b | 0.00 d | 0.00 b | 0.00 e |
| 08. No herbicide | — | 0.00 b | 0.00 d | 0.00 b | 0.00 e |
| 09. — | — | 0.00 a | 0.00 d | 0.00 a | 0.00 e |
| 10. Roundup^{1/} + Heat + Select^{2/} | 3.0 + 50 + 0.75 | 51.25 a | 45.00 c | 51.25 a | 45.00 d |

| | | | | |
|---|---|---|---|---|
| F | 237.18 | 1546.08 | 237.18 | 1546.08 |
| CV (%) | 13.70 | 5.59 | 13.70 | 5.59 |

*Means followed by same letter in the column were clustered in the same group by the Scott Knott test at (p < 0.05).
**Means followed by same letter in the column were clustered in the same group by the Scott Knott test at (p < 0.20).
^{1/}Roundup Original.
^{2/}Applied with Dash 0.5% v v⁻¹.

TABLE 5
Visual weed control (%) (Digitaria insularis) at sowing date, after two applications
(application “A” - 30 days before soybean sowing and application “B” -
5 days before soybean sowing). Data compared at two significance (α) levels (p < 0.05 and p < 0.20).

| | | % control | % control |
|---|---|---|---|
| Treatments | | D. insularis* | D. insularis** |
| Application “A” | Application “B” | 5 DAA-B | 5 DAA-B |
| (30 days before soybean sowing) | (5 days before soybean sowing) | (sowing day) | (sowing day) |
| 01. No herbicide | No herbicide | 0.00 c | 0.00 d |
| 02. Roundup^{1/} + Heat + Onduty ® + Aramo^{2/} | Roundup^{1/} + Heat + Onduty ® + Aramo^{2/} | 95.50 a | 95.50 a |
| | (3.0 L + 50 g + 150 g + 0.8 L) | | |
| 03. Roundup^{1/} + Heat + Onduty ® + Aramo^{2/} | Roundup^{1/} + Heat + Onduty ® + Aramo^{2/} | 91.50 a | 91.50 b |
| | (3.0 L + 50 g + 150 g + 0.8 L) | | |
| 04. — | Roundup^{1/} + Heat + Aramo^{2/} | 27.50 b | 27.50 c |
| | (3.0 L + 50 g + 0.8 L) | | |
| 05. Roundup^{1/} + Heat + Onduty ® + Select^{2/} | Roundup^{1/} + Heat + Onduty ® + Select^{2/} | 97.00 a | 97.00 a |
| | (3.0 L + 50 g + 150 g + 0.75 L) | | |
| 06. Roundup^{1/} + Heat + Onduty ® + Select^{2/} | Roundup^{1/} + Heat + Onduty ® + Select^{2/} | 94.50 a | 94.50 a |
| | (3.0 L + 50 g + 150 g + 0.75 L) | | |
| 07. — | Roundup^{1/} + Heat + Select^{2/} | 23.75 b | 23.75 c |
| | (3.0 L + 50 g + 0.75 L) | | |
| 08. No herbicide | No herbicide | 0.00 c | 0.00 d |
| 09. — | Roundup^{1/} + Heat + Select^{2/} | 28.00 c | 28.00 c |
| | (3.0 L + 50 g + 0.75 L) | | |
| 10. Roundup^{1/} + Heat + Select^{2/} | Roundup^{1/} + Heat + Select^{2/} | 89.50 a | 89.50 b |
| | (3.0 L + 50 g + 0.75 L) | | |

| | | |
|---|---|---|
| F | 301.25 | 301.25 |
| CV (%) | 8.88 | 8.88 |

*Means followed by same letter in the column were clustered in the same group by the Scott Knott test at (p < 0.05).
**Means followed by same letter in the column were clustered in the same group by the Scott Knott test at (p < 0.20).
^{1/}Roundup Original.
^{2/}Applied with Dash 0.5% v v⁻¹.

TABLE 6
Visual weed control (%) (Digitaria insularis) in three evaluations performed after three applications (application “A” - 30
days before soybean sowing; application “B” - 5 days before soybean sowing; and application “C” - plant-and-apply). Data compared at p < 0.05.

| Treatments | | | | | |
|---|---|---|---|---|---|
| Application “A” | Application “B” | Application ”C” | % control D. insularis* | | |
| (30 days before soybean sowing) | (5 days before soybean sowing) | (plant-and-apply) | 07 DAA-C | 22 DAA-C | 42 DAA-C |
| 01. No herbicide | No herbicide | No herbicide | 0.00 d | 0.00 e | 0.00 e |
| 02. Roundup^{1/} + Heat + Onduty + Aramo^{2/} | Roundup^{1/} + Heat + Onduty ® + Aramo^{2/} | — | 95.50 a | 95.75 a | 94.00 a |
| | (3.0 L + 50 g + 150 g + 0.8 L) | | | | |
| 03. Roundup^{1/} + Heat + Onduty + Aramo^{2/} | Roundup^{1/} + Heat + Onduty ® + Aramo^{2/} | — | 93.00 a | 82.50 b | 80.00 b |
| | (3.0 L + 50 g + 150 g + 0.8 L) | | | | |
| 04. — | Roundup^{1/} + Heat + Aramo² | Onduty^{2/} | 51.25 c | 63.75 c | 61.25 c |
| | (3.0 L + 50 g + 0.8 L) | (150 g) | | | |
| 05. Roundup^{1/} + Heat + Onduty + Select^{2/} | Roundup^{1/} + Heat + Onduty ® + Select^{2/} | — | 96.50 a | 92.50 a | 90.00 a |
| | (3.0 L + 50 g + 150 g + 0.75 L) | | | | |
| 06. Roundup^{1/} + Heat + Onduty + Select^{2/} | Roundup^{1/} + Heat + Onduty ® + Select^{2/} | — | 96.00 a | 85.00 b | 80.50 b |
| | (3.0 L + 50 g + 150 g + 0.75 L) | | | | |
| 07. — | Roundup^{1/} + Heat + Select^{2/} | Onduty ®^{2/} | 55.00 c | 67.50 c | 65.00 c |
| | (3.0 L + 50 g + 0.75 L) | (150 g) | | | |
| 08. No herbicide | No herbicide | No herbicide | 0.00 d | 0.00 e | 0.00 e |
| 09. — | Roundup^{1/} + Heat + Select^{2/} | — | 52.00 c | 46.25 d | 46.25 d |
| | (3.0 L + 50 g + 0.75 L) | | | | |
| 10. Roundup^{1/} + Heat + Select^{2/} | Roundup^{1/} + Heat + Select^{2/} | — | 89.25 b | 73.75 b | 63.75 c |
| | (3.0 L + 50 g + 0.75 L) | | | | |

| | | | |
|---|---|---|---|
| F | 861.09 | 131.01 | 221.80 |
| CV (%) | 4.14 | 10.11 | 7.81 |

*Means followed by same letter in the column were clustered in the same group by the Scott Knott test at (p < 0.05).
^{1/}Roundup Original.
^{2/}Applied with Dash 0.5% v v⁻¹.

TABLE 7
Visual weed control (%) (Digitaria insularis) in three evaluations performed after three applications (application “A” - 30
days before soybean sowing; application “B” - 5 days before soybean sowing; and application “C” - plant-and-apply). Data compared at p < 0.20.

| Treatments | | | | | |
|---|---|---|---|---|---|
| Application “A” | Application “B” | Application “C” | % control D. insularis* | | |
| (30 days before soybean sowing) | (5 days before soybean sowing) | (plant-and-apply) | 07 DAA-C | 22 DAA-C | 42 DAA-C |
| 01. No herbicide | No herbicide | No herbicide | 0.00 f | 0.00 f | 0.00 e |
| 02. Roundup^{1/} + Heat + Onduty + Aramo^{2/} | Roundup^{1/} + Heat + Onduty ® + Aramo^{2/} | — | 95.50 a | 95.75 a | 94.00 a |
| | (3.0 L + 50 g + 150 g + 0.8 L) | | | | |
| 03. Roundup^{1/} + Heat + Onduty + Aramo^{2/} | Roundup^{1/} + Heat + Onduty ® + Aramo^{2/} | — | 93.00 b | 82.50 b | 80.00 b |
| | (3.0 L + 50 g + 150 g + 0.8 L) | | | | |
| 04. — | Roundup^{1/} + Heat + Aramo^{2/} | Onduty^{2/} | 51.25 e | 63.75 d | 61.25 c |
| | (3.0 L + 50 g + 0.8 L) | (150 g) | | | |
| 05. Roundup^{1/} + Heat + Onduty + Select^{2/} | Roundup^{1/} + Heat + Onduty ® + Select^{2/} | — | 96.50 a | 92.50 a | 90.00 a |
| | (3.0 L + 50 g + 150 g + 0.75 L) | | | | |
| 06. Roundup^{1/} + Heat + Onduty + Select^{2/} | Roundup^{1/} + Heat + Onduty ® + Select^{2/} | — | 96.00 a | 85.00 b | 80.50 b |
| | (3.0 L + 50 g + 150 g + 0.75 L) | | | | |
| 07. — | Roundup^{1/} + Heat + Select^{2/} | Onduty^{2/} | 55.00 d | 67.50 d | 65.00 c |
| | (3.0 L + 50 g + 0.75 L) | (150 g) | | | |
| 08. No herbicide | No herbicide | No herbicide | 0.00 f | 0.00 f | 0.00 e |
| 09. — | Roundup^{1/} + Heat + Select^{2/} | — | 52.00 e | 46.25 e | 46.25 d |
| | (3.0 L + 50 g + 0.75 L) | | | | |
| 10. Roundup^{1/} + Heat + Select^{2/} | Roundup^{1/} + Heat + Select^{2/} | — | 89.25 c | 73.75 c | 63.75 c |
| | (3.0 L + 50 g + 0.75 L) | | | | |

| | | | |
|---|---|---|---|
| F | 861.09 | 131.01 | 221.80 |
| CV (%) | 4.14 | 10.11 | 7.81 |

*Means followed by same letter in the column were clustered in the same group by the Scott Knott test at (p < 0.20).
^{1/}Roundup Original.
^{2/}Applied with Dash 0.5% v v⁻¹.

TABLE 8
Weed (Digitaria insularis) counts in two evaluations performed after three applications (application “A” - 30 days before
soybean sowing; application “B” - 5 days before soybean sowing; and application “C” - plant-and-apply). Data compared at p < 0.05.

| | | | Density | |
|---|---|---|---|---|
| Treatments | | | D. insularis* | |
| Application “A” | Application “B” | Application “C” | (plants m⁻²) | |
| (30 days before soybean sowing) | (5 days before soybean sowing) | (plant-and-apply) | 22 DAA-C | 42 DAA-C |
| 01. No herbicide | No herbicide | No herbicide | 13.75 c | 16.50c |
| 02. Roundup^{1/} + Heat + Onduty + Aramo^{2/} | Roundup^{1/} + Heat + Onduty ® + Aramo^{2/} | — | 7.00 c | 10.25c |
| | (3.0 L + 50 g + 150 g + 0.8 L) | | | |
| 03. Roundup^{1/} + Heat + Onduty + Aramo^{2/} | Roundup^{1/} + Heat + Onduty ® + Aramo^{2/} | — | 6.75 c | 11.25c |
| | (3.0 L + 50 g + 150 g + 0.8 L) | | | |
| 04. — | Roundup^{1/} + Heat + Aramo² | Onduty ®^{2/} | 9.00 c | 14.25c |
| | (3.0 L + 50 g + 0.8 L) | (150 g) | | |
| 05. Roundup^{1/} + Heat + Onduty + Select^{2/} | Roundup^{1/} + Heat + Onduty ® + Select^{2/} | — | 2.50 c | 8.00c |
| | (3.0 L + 50 g + 150 g + 0.75 L) | | | |
| 06. Roundup^{1/} + Heat + Onduty + Select^{2/} | Roundup^{1/} + Heat + Onduty ® + Select^{2/} | — | 1.25 c | 11.00c |
| | (3.0 L + 50 g + 150 g + 0.75 L) | | | |
| 07. — | Roundup^{1/} + Heat + Select^{2/} | Onduty ®^{2/} | 19.50 c | 27.00c |
| | (3.0 L + 50 g + 0.75 L) | (150 g) | | |
| 08. No herbicide | No herbicide | No herbicide | 16.25 c | 22.00c |
| 09. — | Roundup^{1/} + Heat + Select^{2/} | — | 46.75 b | 60.50b |
| | (3.0 L + 50 g + 0.75 L) | | | |
| 10. Roundup^{1/} + Heat + Select^{2/} | Roundup^{1/} + Heat + Select^{2/} | — | 66.75 a | 101.75a |
| | (3.0 L + 50 g + 0.75 L) | | | |

| | | |
|---|---|---|
| F | 13.65 | 41.66 |
| CV (%) | 60.71 | 32.98 |

*Means followed by same letter in the column were clustered in the same group by the Scott Knott test at (p < 0.05).
^{1/}Roundup Original.
^{2/}Applied with Dash 0.5% v v⁻¹.

TABLE 9
Weed (Digitaria insularis) counts in two evaluations performed after three applications (application “A” - 30 days before
soybean sowing; application “B” - 5 days before soybean sowing; and application “C” - plant-and apply). Data compared at p < 0.20.

| | | | Density | |
|---|---|---|---|---|
| Treatments | | | D. insularis* | |
| Application “A” | Application “B” | Application “C” | (plants m⁻²) | |
| (30 days before soybean sowing) | (5 days before soybean sowing) | (plant-and-apply) | 22 DAA-C | 42 DAA-C |
| 01. No herbicide | No herbicide | No herbicide | 13.75 c | 16.50d |
| 02. Roundup^{1/} + Heat + Onduty + Aramo^{2/} | Roundup^{1/} + Heat + Onduty ® + Aramo^{2/} | — | 7.00 c | 10.25d |
| | (3.0 L + 50 g + 150 g + 0.8 L) | | | |
| 03. Roundup^{1/} + Heat + Onduty + Aramo^{2/} | Roundup^{1/} + Heat + Onduty ® + Aramo^{2/} | — | 6.75 c | 11.25d |
| | (3.0 L + 50 g + 150 g + 0.8 L) | | | |
| 04. — | Roundup^{1/} + Heat + Aramo² | Onduty ®^{2/} | 9.00 c | 14.25d |
| | (3.0 L + 50 g + 0.8 L) | (150 g) | | |
| 05. Roundup^{1/} + Heat + Onduty + Select^{2/} | Roundup^{1/} + Heat + Onduty ® + Select^{2/} | — | 2.50 c | 8.00d |
| | (3.0 L + 50 g + 150 g + 0.75 L) | | | |
| 06. Roundup^{1/} + Heat + Onduty + Select^{2/} | Roundup¹/ + Heat + Onduty ® + Select^{2/} | — | 1.25 c | 11.00d |
| | (3.0 L + 50 g + 150 g + 0.75 L) | | | |
| 07. — | Roundup^{1/} + Heat + Select^{2/} | Onduty ®^{2/} | 19.50 c | 27.00c |
| | (3.0 L + 50 g + 0.75 L) | (150 g) | | |
| 08. No herbicide | No herbicide | No herbicide | 16.25 c | 22.00c |
| 09. — | Roundup^{1/} + Heat + Select^{2/} | — | 46.75 b | 60.50b |
| | (3.0 L + 50 g + 0.75 L) | | | |
| 10. Roundup^{1/} + Heat + Select^{2/} | Roundup^{1/} + Heat + Select^{2/} | — | 66.75 a | 101.75a |
| | (3.0 L + 50 g + 0.75 L) | | | |

| | | |
|---|---|---|
| F | 13.65 | 41.66 |
| CV (%) | 60.71 | 32.98 |

*Means followed by same letter in the column were clustered in the same group by the Scott Knott test at (p < 0.20).
^{1/}Roundup Original.
^{2/}Applied with Dash 0.5% v v⁻¹.

TABLE 10
Visual weed control (%) (Digitaria insularis) at 18 DAA-D after four applications (application “A” -
30 days before soybean sowing; application “B” - 5 days before soybean sowing; application “C” -
plant-and-apply; and application “D” - 42 days after soybean sowing). Data compared at p < 0.05 and p < 0.20.

| Treatments | | | | | |
|---|---|---|---|---|---|
| Application “A” | | | Application “D” | | |
| (30 days before soybean | Application “B” | Application ”C” | (42 days after | % control Digitaria insularis | |
| sowing) | (5 days before soybean sowing) | (plant-and-apply) | soybean sowing) | 18 DAA-D* | 18 DAA-D** |
| 01. No herbicide | No herbicide | No herbicide | No herbicide | 0.00 c | 0.00 e |
| 02. Roundup^{1/} + Heat + | Roundup^{1/} + Heat + Onduty + | — | — | 96.00 a | 96.00 a |
| Onduty + Aramo^{2/} | Aramo^{2/} | | | | |
| | (3.0 L + 50 g + 150 g + 0.8 L) | | | | |
| 03. Roundup^{1/} + Heat + | Roundup^{1/} + Heat + Onduty + | — | — | 73.75 b | 73.75 d |
| Onduty + Aramo^{2/} | Aramo^{2/} | | | | |
| | (3.0 L + 50 g + 150 g + 0.8 L) | | | | |
| 04. — | Roundup^{1/} + Heat + Aramo² | Onduty^{2/} | Aramo^{3/} | 83.25 b | 83.25 c |
| | (3.0 L + 50 g + 0.8 L) | (150 g) | (0.5 L) | | |
| 05. Roundup^{1/} + Heat + | Roundup^{1/} + Heat + Onduty + | — | — | 94.50 a | 94.50 a |
| Onduty + Select^{2/} | Select^{2/} | | | | |
| | (3.0 L + 50 g + 150 g + 0.75 L) | | | | |
| 06. Roundup^{1/} + Heat + | Roundup^{1/} + Heat + Onduty + | — | — | 83.50 b | 83.50 c |
| Onduty + Select^{2/} | Select^{2/} | | | | |
| | (3.0 L + 50 g + 150 g + 0.75 L) | | | | |
| 07. — | Roundup^{1/} + Heat + Select^{2/} | Onduty^{2/} | Select^{3/} | 82.50 b | 82.50 c |
| | (3.0 L + 50 g + 0.75 L) | (150 g) | (0.45 L) | | |
| 08. No herbicide | No herbicide | No herbicide | No herbicide | 0.00 c | 0.00 e |
| 09. — | Roundup^{1/} + Heat + Select^{2/} | — | Roundup Ready + | 78.00 b | 78.00 d |
| | (3.0 L + 50 g + 0.75 L) | | Select^{3/} | | |
| | | | (2.0 L + 0.45 L) | | |
| 10. Roundup^{1/} + Heat + | Roundup^{1/} + Heat + Select^{2/} | — | Roundup Ready + | 88.75 a | 88.75 b |
| Select^{2/} | (3.0 L + 50 g + 0.75 L) | | Select^{3/} | | |
| | | | (2.0 L + 0.45 L) | | |

| | | |
|---|---|---|
| F | 173.39 | 173.39 |
| CV (%) | 8.15 | 8.15 |

*Means followed by same letter in the column were clustered in the same group by the Scott Knott test at (p < 0.05).
**Means followed by same letter in the column were clustered in the same group by the Scott Knott test at (p < 0.20).
^{1/}Roundup Original.;
^{2/}Applied with Dash 0.5% v v⁻¹;
^{3/}Applied with Assist 0.5% v v⁻1

TABLE 11
Weed (Digitaria insularis) counts at 18 DAA-D after four applications (application “A” -
30 days before soybean sowing; application “B” - 5 days before soybean sowing; application
“C” - plant-and-apply; and application “D” - 42 days after soybean sowing). Data compared at p < 0.05 and p < 0.20.

| Treatments | | | | Density | |
|---|---|---|---|---|---|
| Application “A” | | | Application “D” | D. insularis | |
| (30 days before soybean | Application “B” | Application “C” | (42 days after | (plants m⁻²) | |
| sowing) | (5 days before soybean sowing) | (plant-and-apply) | soybean sowing) | 18 DAA-D* | 18 DAA-D** |
| 01. No herbicide | No herbicide | No herbicide | No herbicide | 164.50a | 164.50a |
| 02. Roundup^{1/} + Heat + | Roundup^{1/} + Heat + Onduty + | — | — | 70.75 b | 70.75 c |
| Onduty + Aramo^{2/} | Aramo^{2/} | | | | |
| | (3.0 L + 50 g + 150 g + 0.8 L) | | | | |
| 03. Roundup^{1/} + Heat + | Roundup^{1/} + Heat + Onduyt + | — | — | 88.25 b | 88.25 b |
| Onduty + Aramo^{2/} | Aramo^{2/} | | | | |
| | (3.0 L + 50 g + 150 g + 0.8 L) | | | | |
| 04. — | Roundup^{1/} + Heat + Aramo² | Onduty^{2/} | Aramo^{3/} | 96.25 b | 96.25 b |
| | (3.0 L + 50 g + 0.8 L) | (150 g) | (0.5 L) | | |
| 05. Roundup^{1/} + Heat + | Roundup^{1/} + Heat + Onduty + | — | — | 56.00 b | 56.00 c |
| Onduty + Select^{2/} | Select^{2/} | | | | |
| | (3.0 L + 50 g + 150 g + 0.75 L) | | | | |
| 06. Roundup^{1/} + Heat + | Roundup^{1/} + Heat + Onduty + | — | — | 59.50 b | 59.50 c |
| Onduty + Select^{2/} | Select^{2/} | | | | |
| | (3.0 L + 50 g + 150 g + 0.75 L) | | | | |
| 07. — | Roundup^{1/} + Heat + Select^{2/} | Onduty^{2/} | Select^{3/} | 96.00 b | 96.00 b |
| | (3.0 L + 50 g + 0.75 L) | (150 g) | (0.45 L) | | |
| 08. No herbicide | No herbicide | No herbicide | No herbicide | 141.25 a | 141.25 a |
| 09. — | Roundup^{1/} + Heat + Select^{2/} | — | Roundup Ready + | 108.25 b | 108.25 b |
| | (3.0 L + 50 g + 0.75 L) | | Select^{3/} | | |
| | | | (2.0 L + 0.45 L) | | |
| 10. Roundup^{1/} + Heat + | Roundup^{1/} + Heat + Select^{2/} | — | Roundup Ready + | 155.00 a | 155.00 a |
| Select^{2/} | (3.0 L + 50 g + 0.75 L) | | Select^{3/} | | |
| | | | (2.0 L + 0.45 L) | | |

| | | |
|---|---|---|
| F | 6.41 | 6.41 |
| CV (%) | 29.47 | 29.47 |

*Means followed by same letter in the column were clustered in the same group by the Scott Knott test at (p < 0.05).
**Means followed by same letter in the column were clustered in the same group by the Scott Knott test at (p < 0.20).
^{1/}Roundup Original;
^{2/}Applied with Dash 0.5% v v⁻¹;
^{3/}Applied with Assist 0.5% v v⁻¹.

TABLE 12
Visual weed control (%) (Conyza spp.) in two evaluations after application
“A” (30 days before crop sowing). Data compared at p < 0.05.
Treatments

| (only herbicides in application “A”, | | % control Conyza spp.* | |
|---|---|---|---|
| 30 days before crop sowing) | L or g c.p. ha⁻¹ | 17 DAA-A | 25 DAA-A |
| 01. No herbicide | — | 0.00 c | 0.00 c |
| 02. Roundup^{1/} + Heat + Onduty + Aramo^{2/} | 3.0 + 50 + 150 + 0.8 | 86.25 b | 82.50 a |
| 03. Roundup^{1/} + Heat + Onduty + Aramo^{2/} | 3.0 + 50 + 100 + 0.8 | 94.25 a | 83.75 a |
| 04. — | | 0.00 c | 0.00 c |
| 05. Roundup^{1/} + Heat + Onduty + Select^{2/} | 3.0 + 50 + 150 + 0.75 | 85.00 b | 85.00 a |
| 06. Roundup^{1/} + Heat + Onduty + Select^{2/} | 3.0 + 50 + 100 + 0.75 | 86.25 b | 83.75 a |
| 07. — | | 0.00 c | 0.00 c |
| 08. No herbicide | | 0.00 c | 0.00 c |
| 09. — | | 0.00 c | 0.00 c |
| 10. Roundup^{1/} + Heat + Select^{2/} | 3.0 + 50 + 0.75 | 83.75 b | 74.50 b |

| | | |
|---|---|---|
| F | 640.34 | 841.33 |
| CV (%) | 8.35 | 7.28 |

*Means followed by same letter in the column were clustered in the same group by the Scott Knott test at (p < 0.05).
^{1/}Roundup Original.
^{2/}Applied with Dash 0.5% v v⁻¹.

TABLE 13
Visual weed control (%) (Conyza spp.) at sowing date, after two applications
(application “A” - 30 days before soybean sowing and application
“B” - 5 days before soybean sowing). Data compared at p < 0.05.

| | | % control |
|---|---|---|
| Treatments | | Conyza spp* |
| Application “A” | Application “B” | 5 DAA-B |
| (30 days before soybean sowing) | (5 days before soybean sowing) | (sowing day) |
| 01. No herbicide | No herbicide | 0.00 c |
| 02. Roundup^{1/} + Heat + Onduty + Aramo^{2/} | Roundup^{1/} + Heat + Onduty + Aramo^{2/} | 97.50 a |
| (3.0 L + 50 g + 150 g + 0.8 L) | (3.0 L + 50 g + 150 g + 0.8 L) | |
| 03. Roundup^{1/} + Heat + Onduty + Aramo^{2/} | Roundup^{1/} + Heat + Onduty + Aramo^{2/} | 94.50 a |
| (3.0 L + 50 g + 100 g + 0.8 L) | (3.0 L + 50 g + 150 g + 0.8 L) | |
| 04. — | Roundup^{1/} + Heat + Aramo^{2/} | 32.00 b |
| | (3.0 L + 50 g + 0.8 L) | |
| 05. Roundup^{1/} + Heat + Onduty + Select^{2/} | Roundup^{1/} + Heat + Onduty + Select^{2/} | 93.50 a |
| (3.0 L + 50 g + 150 g + 0.75 L) | (3.0 L + 50 g + 150 g + 0.75 L) | |
| 06. Roundup^{1/} + Heat + Onduty + Select^{2/} | Roundup^{1/} + Heat + Onduty + Select^{2/} | 95.50 a |
| (3.0 L + 50 g + 100 g + 0.75 L) | (3.0 L + 50 g + 150 g + 0.75 L) | |
| 07. — | Roundup^{1/} + Heat + Select^{2/} | 30.50 b |
| | (3.0 L + 50 g + 0.75 L) | |
| 08. No herbicide | No herbicide | 0.00 c |
| 09. — | Roundup^{1/} + Heat + Select^{2/} | 25.00 b |
| | (3.0 L + 50 g + 0.75 L) | |
| 10. Roundup^{1/} + Heat + Select^{2/} | Roundup^{1/} + Heat + Select^{2/} | 95.00 a |
| (3.0 L + 50 g + 0.75 L) | (3.0 L + 50 g + 0.75 L) | |

| | |
|---|---|
| F | 114.01 |
| CV (%) | 14.08 |

*Means followed by same letter in the column were clustered in the same group by the Scott Knott test at (p < 0.05).
^{1/}Roundup Original.
^{2/}Applied with Dash 0.5% v v⁻¹.

TABLE 14
Visual weed control (%) (Conyza spp.) in three evaluations performed after three applications (application “A” - 30 days
before soybean sowing; application “B” - 5 days before soybean sowing; and application “C” - plant-and-apply). Data compared at p < 0.05.

| Treatments | | | | | |
|---|---|---|---|---|---|
| Application “A” | Application “B” | Application “C” | % control Conyza spp. | | |
| (30 days before soybean sowing) | (5 days before soybean sowing) | (plant-and-apply) | 07 DAA-C | 22 DAA-C | 42 DAA-C |
| 01. No herbicide | No herbicide | No herbicide | 0.00 c | 0.00 e | 0.00 e |
| 02. Roundup^{1/} + Heat + Onduty + Aramo^{2/} | Roundup^{1/} + Heat + Onduty + Aramo^{2/} | — | 95.75 a | 97.50 a | 98.00 a |
| (3.0 L + 50 g + 150 g + 0.8 L) | (3.0 L + 50 g + 150 g + 0.8 L) | | | | |
| 03. Roundup^{1/} + Heat + Onduty + Aramo^{2/} | Roundup^{1/} + Heat + Onduty + Aramo^{2/} | — | 97.75 a | 97.00 a | 96.75 a |
| (3.0 L + 50 g + 100 g + 0.8 L) | (3.0 L + 50 g + 150 g + 0.8 L) | | | | |
| 04. — | Roundup^{1/} + Heat + Aramo^{2/} | Onduty² | 53.25 b | 63.75 c | 58.75 c |
| | (3.0 L + 50 g + 0.8 L) | (150 g) | | | |
| 05. Roundup^{1/} + Heat + Onduty + Select^{2/} | Roundup^{1/} + Heat + Onduty + Select^{2/} | — | 97.75 a | 97.25 a | 97.25 a |
| (3.0 L + 50 g + 150 g + 0.75 L) | (3.0 L + 50 g + 150 g + 0.75 L) | | | | |
| 06. Roundup^{1/} + Heat + Onduty + Select^{2/} | Roundup^{1/} + Heat + Onduty + Select^{2/} | — | 97.50 a | 97.25 a | 97.75 a |
| (3.0 L + 50 g + 100 g + 0.75 L) | (3.0 L + 50 g + 150 g + 0.75 L) | | | | |
| 07. — | Roundup^{1/} + Heat + Select^{2/} | Onduty² | 54.25 b | 60.00 c | 56.25 c |
| | (3.0 L + 50 g + 0.75 L) | (150 g) | | | |
| 08. No herbicide | No herbicide | No herbicide | 0.00 c | 0.00 e | 0.00 e |
| 09. — | Roundup^{1/} + Heat + Select^{2/} | — | 53.75 b | 43.75 d | 41.25 d |
| | (3.0 L + 50 g + 0.75 L) | | | | |
| 10. Roundup^{1/} + Heat + Select^{2/} | Roundup^{1/} + Heat + Select^{2/} | — | 96.50 a | 91.25 b | 90.00 b |
| (3.0 L + 50 g + 0.75 L) | (3.0 L + 50 g + 0.75 L) | | | | |

| | | | |
|---|---|---|---|
| F | 773.15 | 479.93 | 511.26 |
| CV (%) | 4.38 | 5.51 | 8.46 |

*Means followed by same letter in the column were clustered in the same group by the Scott Knott test at (p < 0.05).
^{1/}Roundup Original.
^{2/}Applied with Dash 0.5% v v⁻¹.

TABLE 15
Visual weed control (%) (Conyza spp.) at 18 DAA-D after four applications (application “A” -
30 days before soybean sowing; application “B” - 5 days before soybean sowing; application
“C” - plant-and-apply; and application “D” - 42 days after soybean sowing). Data compared at p < 0.05.

| Treatments | | | | |
|---|---|---|---|---|
| | | | Application “D” | % control |
| Application “A” | Application “B” | Application “C” | (42 days after | Conyza spp* |
| (30 days before soybean sowing) | (5 days before soybean sowing) | (plant-and-apply) | soybean sowing) | 18 DAA-D |
| 01. No herbicide | No herbicide | No herbicide | No herbicide | 0.00 e |
| 02. Roundup^{1/} + Heat + Onduty + Aramo^{2/} | Roundup^{1/} + Heat + Onduty + Aramo^{2/} | — | — | 98.25 a |
| (3.0 L + 50 g + 150 g + 0.8 L) | (3.0 L + 50 g + 150 g + 0.8 L) | | | |
| 03. Roundup^{1/} + Heat + Onduty + Aramo^{2/} | Roundup^{1/} + Heat + Onduty + Aramo^{2/} | — | — | 97.50 a |
| (3.0 L + 50 g + 100 g + 0.8 L) | (3.0 L + 50 g + 150 g + 0.8 L) | | | |
| 04. — | Roundup^{1/} + Heat + Aramo^{2/} | Onduty^{2/} | Aramo^{3/} | 56.25 c |
| | (3.0 L + 50 g + 0.8 L) | (150 g) | (0.5 L) | |
| 05. Roundup^{1/} + Heat + Onduty + Select^{2/} | Roundup^{1/} + Heat + Onduty + Select^{2/} | — | — | 98.50 a |
| (3.0 L + 50 g + 150 g + 0.75 L) | (3.0 L + 50 g + 150 g + 0.75 L) | | | |
| 06. Roundup^{1/} + Heat + Onduty + Select^{2/} | Roundup^{1/} + Heat + Onduty + Select^{2/} | — | — | 98.00 a |
| (3.0 L + 50 g + 100 g + 0.75 L) | (3.0 L + 50 g + 150 g + 0.75 L) | | | |
| 07. — | Roundup^{1/} + Heat + Select^{2/} | Onduty^{2/} | Select^{3/} | 57.25 c |
| | (3.0 L + 50 g + 0.75 L) | (150 g) | (0.45 L) | |
| 08. No herbicide | No herbicide | No herbicide | No herbicide | 0.00 e |
| 09. — | Roundup^{1/} + Heat + Select^{2/} | — | Roundup Ready + | 37.50 d |
| | (3.0 L + 50 g + 0.75 L) | | Select^{3/} | |
| | | | (2.0 L + 0.45 L) | |
| 10. Roundup^{1/} + Heat + Select^{2/} | Roundup^{1/} + Heat + Select^{2/} | — | Roundup Ready + | 85.50 b |
| (3.0 L + 50 g + 0.75 L) | (3.0 L + 50 g + 0.75 L) | | Select^{3/} | |
| | | | (2.0 L + 0.45 L) | |

| | |
|---|---|
| F | 50.73 |
| CV (%) | 17.83 |

*Means followed by same letter in the column were clustered in the same group by the Scott Knott test at (p < 0.05).
^{1/}Roundup Original.
^{2/}Applied with Dash 0.5% v v⁻¹;
^{3/}Applied with Assist 0.5% v v⁻¹

### Example 2

Location:

The study was carried out in Brazil.

Treatments:

All treatments assessed are shown in Table 16.

Method:

All treatments were applied in established weeds, post emergence, before weeds flowering. The treatments were applied using backpressure equipment (nozzles TEEJET8002) with a water consumption of 150 liters per hectare, 1.2 BAR.

Assessment and Assessed Criteria:

14, 21, 28, 35 and 42 days after application (“DAA”) evaluations were carried out, i.e. measuring the control of Trichachne insularis (Digitaria insularis) and its regrowth. The assessment consisted in a visual control level of weeds in which 0% related to absence of control and 100% to total control of weeds. The regrowth were assessed by comparing the emergence of new tillers in treatments versus the emergence of new tillers in check (non-treated control).

Data Analysis:

An analysis was carried out for viability rates applied through a variance analysis and a mean comparison test of Student—Newman-Keuls (P=0.5) with the ARM® statistical analysis package.

Results:

control of and regrowth of D. insularis is shown in Table 16 and 17 respectively.

TABLE 16

| | | 14 DAA | | | 21 DAA | | |
|---|---|---|---|---|---|---|---|
| Treatments | Dose (g a.e. or ai/ha) | % of control | | Theoritical | Proved | | Calculated |
| 01. Glyphosate | 1080 | 11.25 | h | | 8.75 | h | |
| 02. Clethodim | 192 | 45 | c | | 60 | d | |
| 03. [Imazapic + Imazapyr] | [36.75 + 12.25] | 11.25 | h | | 13.75 | h | |
| 04. [Imazapic + Imazapyr] | [78.75 + 26.25] | 22.5 | f | | 36.25 | f | |
| 05. Saflufenacil | 24.5 | 15 | g | | 11.25 | h | |
| 06. Saflufenacil | 49 | 18.75 | g | | 16.25 | g | |
| 07. Glyphosate + | 1080 + 192 | 50 | c | | 74.5 | b | 63.50 |
| Clethodim | | | | | | | |
| 08. Glyphosate + | 1080 + [36.75 + 12.25] | 48.75 | c | 21.23 | 60 | d | 21.30 |
| [Imazapic + Imazapyr] | | | | | | | |
| 09. Glyphosate + | 1080 + [78.75 + 26.25] | 61.25 | b | 31.22 | 68.25 | c | 41.83 |
| [Imazapic + Imazapyr] | | | | | | | |
| 10. Glyphosate + | 1080 + 24.5 | 16.25 | g | 24.56 | 13.75 | h | 19.02 |
| Saflufenacil | | | | | | | |
| 11. Glyphosate + | 1080 + 49 | 23.75 | f | 27.89 | 21.25 | g | 23.58 |
| Saflufenacil | | | | | | | |
| 12. Clethodim + | 192 + [36.75 + 12.25] | 50 | c | 51.19 | 58.75 | d | 65.50 |
| [Imazapic + Imazapyr] | | | | | | | |
| 13. Clethodim + | 192 + [78.75 + 26.25] | 60 | b | 57.38 | 66.25 | c | 74.50 |
| [Imazapic + Imazapyr] | | | | | | | |
| 14. Clethodim + | 192 + 24.5 | 68.75 | a | 53.25 | 67 | c | 64.50 |
| Saflufenacil | | | | | | | |
| 15. Clethodim + | 192 + 49 | 67.5 | a | 55.31 | 73.25 | b | 66.50 |
| Saflufenacil | | | | | | | |
| 16. [Imazapic + Imazapyr] + | [36.75 + 12.25] + 24.5 | 18.75 | g | 24.56 | 15 | g | 23.45 |
| Saflufenacil | | | | | | | |
| 17. [Imazapic + Imazapyr] + | [36.75 + 12.25] + 49 | 15 | g | 27.89 | 16.25 | g | 27.77 |
| Saflufenacil | | | | | | | |
| 18. [Imazapic + Imazapyr] + | [78.75 + 26.25] + 24.5 | 27.25 | f | 34.13 | 48.75 | e | 43.42 |
| Saflufenacil | | | | | | | |
| 19. [Imazapic + Imazapyr] + | [78.75 + 26.25] + 49 | 26.25 | f | 37.03 | 45 | e | 46.61 |
| Saflufenacil | | | | | | | |
| 20. Glyphosate + | 1080 + 192 + [36.75 + 12.25] | 57.5 | b | 55.55 | 73.75 | b | 70.07 |
| Clethodim + | | | | | | | |
| [Imazapic + Imazapyr] | | | | | | | |
| 21. Glyphosate + | 1080 + 192 + [78.75 + 26.25] | 65.75 | a | 59.9 | 78.75 | b | 73 |
| Clethodim + | | | | | | | |
| [Imazapic + Imazapyr] | | | | | | | |
| 22. Glyphosate + | 1080 + 192 + 24.5 | 40 | d | 57 | 67.5 | c | 66.43 |
| Clethodim + Saflufenacil | | | | | | | |
| 23. Glyphosate + | 1080 + 192 + 49 | 46.25 | c | 58.44 | 70 | c | 67.7 |
| Clethodim + Saflufenacil | | | | | | | |
| 24. Glyphosate + | 1080 + [36.75 + 12.25] + 24.5 | 33.75 | e | 32.66 | 51.25 | e | 29.9 |
| [Imazapic + Imazapyr] + | | | | | | | |
| Saflufenacil | | | | | | | |
| 25. Glyphosate + | 1080 + [36.75 + 12.25] + 49 | 41.25 | d | 36.37 | 58.75 | d | 33.69 |
| [Imazapic + Imazapyr] + | | | | | | | |
| Saflufenacil | | | | | | | |
| 26. Glyphosate + | 1080 + [78.75 + 26.25] + 24.5 | 46.25 | c | 40.76 | 68.75 | c | 47.66 |
| [Imazapic + Imazapyr] + | | | | | | | |
| Saflufenacil | | | | | | | |
| 27. Glyphosate + | 1080 + [78.75 + 26.25] + 49 | 52.5 | c | 43.166 | 71.25 | c | 50.25 |
| [Imazapic + Imazapyr] + | | | | | | | |
| Saflufenacil | | | | | | | |
| 28. Clethodim + | 192 + [36.75 + 12.25] + 24.5 | 38.75 | d | 57 | 55 | d | 67.52 |
| [Imazapic + Imazapyr] + | | | | | | | |
| Saflufenacil | | | | | | | |
| 29. Clethodim + | 192 + [36.75 + 12.25] + 49 | 36.25 | e | 58.44 | 55 | d | 68.43 |
| [Imazapic + Imazapyr] + | | | | | | | |
| Saflufenacil | | | | | | | |
| 30. Clethodim + | 192 + [78.75 + 26.25] + 24.5 | 47.5 | c | 60.73 | 74.5 | b | 72.4 |
| [Imazapic + Imazapyr] + | | | | | | | |
| Saflufenacil | | | | | | | |
| 31. Clethodim + | 192 + [78.75 + 26.25] + 49 | 50 | c | 61.5 | 72.5 | b | 71.58 |
| [Imazapic + Imazapyr] + | | | | | | | |
| Saflufenacil | | | | | | | |
| 32. Glyphosate + | 1080 + 192 + [36.75 + 12.25] + 24.5 | 62.5 | b | 58.63 | 76.25 | b | 67.38 |
| Clethodim + | | | | | | | |
| [Imazapic + Imazapyr] + | | | | | | | |
| Saflufenacil | | | | | | | |
| 33. Glyphosate + | 1080 + 192 + [36.75 + 12.25] + 49 | 64.5 | a | 59.42 | 78.75 | b | 67.49 |
| Clethodim + | | | | | | | |
| [Imazapic + Imazapyr] + | | | | | | | |
| Saflufenacil | | | | | | | |
| 34. Glyphosate + | 1080 + 192 + [78.75 + 26.25] + 24.5 | 67.5 | a | 60.3 | 87 | a | 68.78 |
| Clethodim + | | | | | | | |
| [Imazapic + Imazapyr] + | | | | | | | |
| Saflufenacil | | | | | | | |
| 35. Glyphosate + | 1080 + 192 + [78.75 + 26.25] + 49 | 70 | a | 59.8 | 91.25 | a | 66.92 |
| Clethodim + | | | | | | | |
| [Imazapic + Imazapyr] + | | | | | | | |
| Saflufenacil | | | | | | | |
| 36. No herbicides | — | 0 | | | 0 | i | |

| | 28 DAA | | | 35 DAA | | | 42 DAA | | |
|---|---|---|---|---|---|---|---|---|---|
| Treatments | Proved | | Calc. | Proved | | Calc. | Proved | | Calc. |
| 01. Glyphosate | 8.75 | h | | 6.25 | j | | 3.75 | d | |
| 02. Clethodim | 62.5 | c | | 60 | e | | 52.5 | b | |
| 03. [Imazapic + Imazapyr] | 16.25 | g | | 12.5 | i | | 12.5 | d | |
| 04. [Imazapic + Imazapyr] | 47.5 | d | | 40 | g | | 32.5 | c | |
| 05. Saflufenacil | 5 | h | | 5 | j | | 2.5 | d | |
| 06. Saflufenacil | 6.25 | h | | 6.25 | j | | 2.5 | d | |
| 07. Glyphosate + | 76.25 | b | 65.78 | 70 | c | 65.47 | 60 | a | 54.28 |
| Clethodim | | | | | | | | | |
| 08. Glyphosate + | 63.25 | c | 23.58 | 58.75 | e | 17.97 | 45 | b | 15.78 |
| [Imazapic + Imazapyr] | | | | | | | | | |
| 09. Glyphosate + | 72 | c | 52.09 | 74.25 | c | 43.75 | 71.25 | a | 35.03 |
| [Imazapic + Imazapyr] | | | | | | | | | |
| 10. Glyphosate + | 13.75 | g | 13.31 | 11.25 | i | 10.94 | 6.25 | d | 6.16 |
| Saflufenacil | | | | | | | | | |
| 11. Glyphosate + | 20 | f | 52.09 | 17.5 | i | 12.11 | 7.5 | d | 6.16 |
| Saflufenacil | | | | | | | | | |
| 12. Clethodim + | 65 | c | 68.59 | 65 | d | 71.72 | 50 | b | 58.44 |
| [Imazapic + Imazapyr] | | | | | | | | | |
| 13. Clethodim + | 68.75 | c | 80.31 | 67.5 | d | 76.00 | 61.25 | a | 67.94 |
| [Imazapic + Imazapyr] | | | | | | | | | |
| 14. Clethodim + | 64.25 | c | 64.38 | 58.75 | e | 62.00 | 53.75 | b | 53.69 |
| Saflufenacil | | | | | | | | | |
| 15. Clethodim + | 58.75 | d | 64.84 | 63.25 | d | 12.11 | 65 | a | 53.69 |
| Saflufenacil | | | | | | | | | |
| 16. [Imazapic + Imazapyr] + | 32.5 | e | 20.44 | 26.25 | h | 16.88 | 8.75 | d | 14.69 |
| Saflufenacil | | | | | | | | | |
| 17. [Imazapic + Imazapyr] + | 33.75 | e | 21.48 | 33.75 | g | 17.97 | 12.5 | d | 14.69 |
| Saflufenacil | | | | | | | | | |
| 18. [Imazapic + Imazapyr] + | 55 | d | 50.13 | 50 | f | 43.00 | 40 | b | 34.19 |
| Saflufenacil | | | | | | | | | |
| 19. [Imazapic + Imazapyr] + | 51.25 | d | 50.78 | 50 | f | 43.75 | 41.25 | b | 34.19 |
| Saflufenacil | | | | | | | | | |
| 20. Glyphosate + | 83.25 | b | 69.57 | 80 | b | 66.3 | 61.25 | a | 59.2 |
| Clethodim + | | | | | | | | | |
| [Imazapic + Imazapyr] | | | | | | | | | |
| 21. Glyphosate + | 86.25 | a | 76.83 | 82.5 | b | 14.5 | 67.5 | a | 67.9 |
| Clethodim + | | | | | | | | | |
| [Imazapic + Imazapyr] | | | | | | | | | |
| 22. Glyphosate + | 67.5 | c | 67 | 61.25 | e | 64 | 48.75 | b | 55.4 |
| Clethodim + Saflufenacil | | | | | | | | | |
| 23. Glyphosate + | 77 | b | 67.25 | 67.5 | d | 64.38 | 56.25 | b | 55.4 |
| Clethodim + Saflufenacil | | | | | | | | | |
| 24. Glyphosate + | 62 | c | 27.3 | 45 | f | 22 | 31.25 | c | 17.9 |
| [Imazapic + Imazapyr] + | | | | | | | | | |
| Saflufenacil | | | | | | | | | |
| 25. Glyphosate + | 68.75 | c | 28.19 | 40 | g | 23 | 37.5 | b | 17.9 |
| [Imazapic + Imazapyr] + | | | | | | | | | |
| Saflufenacil | | | | | | | | | |
| 26. Glyphosate + | 85 | a | 54.1 | 81.25 | b | 46.32 | 67.5 | a | 36.6 |
| [Imazapic + Imazapyr] + | | | | | | | | | |
| Saflufenacil | | | | | | | | | |
| 27. Glyphosate + | 83 | b | 54.6 | 82.5 | b | 47 | 68.75 | a | 36.6 |
| [Imazapic + Imazapyr] + | | | | | | | | | |
| Saflufenacil | | | | | | | | | |
| 28. Clethodim + | 76.25 | b | 69.17 | 57.5 | e | 66 | 53.75 | b | 59.1 |
| [Imazapic + Imazapyr] + | | | | | | | | | |
| Saflufenacil | | | | | | | | | |
| 29. Clethodim + | 70 | c | 69.3 | 58.75 | e | 66 | 42.5 | b | 59.1 |
| [Imazapic + Imazapyr] + | | | | | | | | | |
| Saflufenacil | | | | | | | | | |
| 30. Clethodim + | 76.25 | b | 78.32 | 71.25 | c | 74.8 | 58.75 | a | 67.9 |
| [Imazapic + Imazapyr] + | | | | | | | | | |
| Saflufenacil | | | | | | | | | |
| 31. Clethodim + | 79.5 | b | 77.83 | 75.5 | c | 74.5 | 55 | b | 67.9 |
| [Imazapic + Imazapyr] + | | | | | | | | | |
| Saflufenacil | | | | | | | | | |
| 32. Glyphosate + | 82.5 | b | 69.33 | 75.25 | c | 66.5 | 66.25 | a | 60.05 |
| Clethodim + | | | | | | | | | |
| [Imazapic + Imazapyr] + | | | | | | | | | |
| Saflufenacil | | | | | | | | | |
| 33. Glyphosate + | 81 | b | 68.76 | 76.25 | c | 66.76 | 61.25 | a | 60.05 |
| Clethodim + | | | | | | | | | |
| [Imazapic + Imazapyr] + | | | | | | | | | |
| Saflufenacil | | | | | | | | | |
| 34. Glyphosate + | 93 | a | 73.8 | 90.75 | a | 72.56 | 80.75 | a | 67.62 |
| Clethodim + | | | | | | | | | |
| [Imazapic + Imazapyr] + | | | | | | | | | |
| Saflufenacil | | | | | | | | | |
| 35. Glyphosate + | 93.25 | a | 73.06 | 93 | a | 72.11 | 77.5 | a | 67.62 |
| Clethodim + | | | | | | | | | |
| [Imazapic + Imazapyr] + | | | | | | | | | |
| Saflufenacil | | | | | | | | | |
| 36. No herbicides | 0 | h | | 0 | j | | 0 | d | |

TABLE 17

| Treatments | Dose (g a.e or ai/ha) | 35 DAA | | 42 DAA | |
|---|---|---|---|---|---|
| 01. Glyphosate | 1080 | 61.25 | g | 67.5 | d |
| 02. Clethodim | 192 | 28 | d | 33.75 | b |
| 03. [Imazapic + Imazapyr] | [36.75 + 12.25] | 41.25 | e | 58.75 | c |
| 04. [Imazapic + Imazapyr] | [78.75 + 26.25] | 27.5 | d | 42.5 | b |
| 05. Saflufenacil | 24.5 | 63.75 | g | 72.5 | d |
| 06. Saflufenacil | 49 | 66.5 | g | 78.75 | d |
| 07. Glyphosate + Clethodim | 1080 + 192 | 22.5 | c | 27.5 | b |
| 08. Glyphosate + [Imazapic + Imazapyr] | 1080 + [36.75 + 12.25] | 23.75 | c | 36.25 | b |
| 09. Glyphosate + [Imazapic + Imazapyr] | 1080 + [78.75 + 26.25] | 10.5 | b | 16.25 | a |
| 10. Glyphosate + Saflufenacil | 1080 + 24.5 | 60 | g | 70 | d |
| 11. Glyphosate + Saflufenacil | 1080 + 49 | 32.5 | d | 36.25 | b |
| 12. Clethodim + [Imazapic + Imazapyr] | 192 + [36.75 + 12.25] | 26.25 | d | 36.25 | b |
| 13. Clethodim + [Imazapic + Imazapyr] | 192 + [78.75 + 26.25] | 13 | b | 18.75 | a |
| 14. Clethodim + Saflufenacil | 192 + 24.5 | 27.75 | d | 38.75 | b |
| 15. Clethodim + Saflufenacil | 192 + 49 | 24.75 | c | 28.75 | b |
| 16. [Imazapic + Imazapyr] + Saflufenacil | [36.75 + 12.25] + 24.5 | 53.75 | f | 62.5 | c |
| 17. [Imazapic + Imazapyr] + Saflufenacil | [36.75 + 12.25] + 49 | 42.5 | e | 53.75 | c |
| 18. [Imazapic + Imazapyr] + Saflufenacil | [78.75 + 26.25] + 24.5 | 24.5 | c | 37.5 | b |
| 19. [Imazapic + Imazapyr] + Saflufenacil | [78.75 + 26.25] + 49 | 29.5 | d | 45 | b |
| 20. Glyphosate + Clethodim + [Imazapic + Imazapyr] | 1080 + 192 + [36.75 + 12.25] | 16.25 | b | 26.25 | b |
| 21. Glyphosate + Clethodim + [Imazapic + Imazapyr] | 1080 + 192 + [78.75 + 26.25] | 12.5 | b | 19.5 | a |
| 22. Glyphosate + Clethodim + Saflufenacil | 1080 + 192 + 24.5 | 31.25 | d | 40 | b |
| 23. Glyphosate + Clethodim + Saflufenacil | 1080 + 192 + 49 | 23.75 | c | 36.25 | b |
| 24. Glyphosate + [Imazapic + Imazapyr] + Saflufenacil | 1080 + [36.75 + 12.25] + 24.5 | 25.75 | c | 46.25 | b |
| 25. Glyphosate + [Imazapic + Imazapyr] + Saflufenacil | 1080 + [36.75 + 12.25] + 49 | 25 | c | 38.75 | b |
| 26. Glyphosate + [Imazapic + Imazapyr] + Saflufenacil | 1080 + [78.75 + 26.25] + 24.5 | 9.25 | b | 17.5 | a |
| 27. Glyphosate + [Imazapic + Imazapyr] + Saflufenacil | 1080 + [78.75 + 26.25] + 49 | 8.5 | b | 17.5 | a |
| 28. Clethodim + [Imazapic + Imazapyr] + Saflufenacil | 192 + [36.75 + 12.25] + 24.5 | 23.75 | c | 28 | b |
| 29. Clethodim + [Imazapic + Imazapyr] + Saflufenacil | 192 + [36.75 + 12.25] + 49 | 22.5 | c | 32.5 | b |
| 30. Clethodim + [Imazapic + Imazapyr] + Saflufenacil | 192 + [78.75 + 26.25] + 24.5 | 12.5 | b | 18.75 | a |
| 31. Clethodim + [Imazapic + Imazapyr] + Saflufenacil | 192 + [78.75 + 26.25] + 49 | 12.5 | b | 18.75 | a |
| 32. Glyphosate + Clehtodim + [Imazapic + Imazapyr] + Saflufenacil | 1080 + 192 + [36.75 + 12.25] + 24.5 | 20 | c | 30 | b |
| 33. Glyphosate + Clethodim + [Imazapic + Imazapyr] + Saflufenacil | 1080 + 192 + [36.75 + 12.25] + 49 | 18.75 | c | 35 | b |
| 34. Glyphosate + Clethodim + [Imazapic + Imazapyr] + Saflufenacil | 1080 + 192 + [78.75 + 26.25] + 24.5 | 5.5 | a | 13.75 | a |
| 35. Glyphosate + Clethodim + [Imazapic + Imazapyr] + Saflufenacil | 1080 + 192 + [78.75 + 26.25] + 49 | 5 | a | 12.5 | a |
| 36. No herbicides | — | — | — | — | — |

### Example 3

Location:

The study was carried out in Brazil.

Treatments:

All treatments assessed are shown in Table 18.

Method and Assessment:

The applications carried out by a back pressure sprayer with T-jet nozzles (XR-110.02) covering 200 liters per hectare. At the time of application, Conyza bonariensis weeds were 20 cm height. The results assessed by the comparison between viable weeds at the control plot and the viable weeds at the treatments plots. To the experiment, the plot consist of a 20 m2 area (5 meters length and 4 meters width).

Data Analysis:

The synergy was calculated by Colby formula and it expansion for three-way mixtures

Results:

control of of Conyza bonariensis is shown in Table 18.

The applications carried out by a back pressure sprayer with T-jet nozzles (XR-110.02) covering 200 liters per hectare. At the time of application, Conyza bonariensis weeds were 20 cm height. The results assessed by the comparison between viable weeds at the control plot and the viable weeds at the treatments plots. To the experiment, the plot consist of a 20 m2 area (5 meters length and 4 meters width).

TABLE 18

| Control of Conyza bonariensis | | | | 7 DAA | | 15 DAA | |
|---|---|---|---|---|---|---|---|
| | | Product Rate | | Field | Synergy | Field | Synergy |
| | Active Ingredient | (ml or g/ha) | Dose (g a.i. or a.e./ha) | Results | by colby | Results | by colby |
| 1 | Glyphosate | 3000 | | 32.50 | | 65.00 | |
| 2 | Glufosinate + Saflufenacil | 2500 + 70 | | 91.25 | | 74.50 | |
| 3 | Glyphosate | 3000 | | 15.00 | — | 27.50 | — |
| 4 | Saflufenacil | 35 | 24.5 | 60.00 | — | 56.25 | — |
| 5 | Saflufenacil | 70 | 49 | 86.25 | — | 73.75 | — |
| 6 | (Imazapic + Imazapyr) | 70 | (36.75 + 12.25) | 38.75 | — | 62.00 | — |
| 7 | (Imazapic + Imazapyr) | 150 | (78.75 + 26.25) | 48.75 | — | 66.25 | — |
| 8 | Glyphosate + Saflufenacil | 3000 | 360 + 24.5 | 85.00 | 66.00 | 71.25 | 68.28125 |
| 9 | Glyphosate + Saflufenacil | 3000 | 360 + 49 | 88.75 | 88.31 | 77.50 | 80.96875 |
| 10 | Glyphosate + (Imazapic + Imazapyr) | 3000 | 360 + (36.75 + 12.25) | 51.25 | 47.9375 | 65.00 | 72.45 |
| 11 | Glyphosate + (Imazapic + Imazapyr) | 3000 | 360 + (78.75 + 26.25) | 61.25 | 56.44 | 72.50 | 75.53125 |
| 12 | Saflufenacil + (Imazapic + Imazapyr) | 35 + 70 | 24.5 + (36.75 + 12.25) | 67.50 | 75.50 | 85.75 | 83.375 |
| 13 | Saflufenacil + (Imazapic + Imazapyr) | 35 + 150 | 24.5 + (78.75 + 26.25) | 77.50 | 79.50 | 89.00 | 85.234375 |
| 14 | Saflufenacil + (Imazapic + Imazapyr) | 70 + 70 | 49 + (36.75 + 12.25) | 72.50 | 91.58 | 88.75 | 90.025 |
| 15 | Saflufenacil + (Imazapic + Imazapyr) | 70 + 150 | 49 + (78.75 + 26.25) | 77.50 | 92.95 | 93.75 | 91.140625 |
| 16 | Glyphosate + Saflufenacil + | 3000 + 35 + 70 | 360 + 24.5 + (36.75 + 12.25) | 72.50 | 79.18 | 88.75 | 87.946875 |
| | (Imazapic + Imazapyr) | | | | | | |
| 17 | Glyphosate + Saflufenacil + | 3000 + 35 + 150 | 360 + 24.5 + (78.75 + 26.25) | 78.75 | 82.58 | 93.25 | 89.29492188 |
| | (Imazapic + Imazapyr) | | | | | | |
| 18 | Glyphosate + Saflufenacil + | 3000 + 70 + 70 | 360 + 49 + (36.75 + 12.25) | 76.25 | 92.84 | 91.75 | 92.768125 |
| | (Imazapic + Imazapyr) | | | | | | |
| 19 | Glyphosate + Saflufenacil + | 3000 + 70 + 150 | 360 + 49 + (78.75 + 26.25) | 87.25 | 94.01 | 97.00 | 93.57695313 |
| | (Imazapic + Imazapyr) | | | | | | |

The application further comprises the following items:

Item 1: Herbicidal compositions comprising:

a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof.

Item 2: Herbicidal composition of item 1, wherein the at least one herbicide C is selected from the group consisting of imazapyr, imazapic, imazamox and imazethapyr or their agriculturally acceptable salts.

Item 3: Herbicidal composition of items 1 to 2, wherein the at least one herbicide C is selected from the group consisting of imazapyr and imazapic or their agriculturally acceptable salts.

Item 4: Herbicidal composition of items 1 to 3, wherein the at least one herbicide C is a combination of imazapyr and imazapic or their agriculturally acceptable salts.

Item 5: The use of the compositions as described in any of the preceding items for controlling undesirable vegetation.

Item 6: A method for controlling undesirable vegetation, which comprises allowing a composition as described in items 1 to 4 to act on herbicide resistant plants or their habitat.

Item 7: The use of item 5 or the method of item 6, wherein the undesirable vegetation is controlled in crop plants.

Item 8: The use or method of item 7, wherein the crop plants are soybean.

Item 9: The use or method of items 5 to 8, wherein the undesirable vegetation are herbicide resistant weeds or herbicide resistant dicotyledonous volunteer crops.

Item 10: The use or method of items 5 to 9, wherein the undesirable vegetation is resistant to the herbicides such as glyphosate, dicamba, 2,4-dichlorophenoxyethanoic acid, glufosinate, ACCase inhibitors, HPPD inhibitors and/or acetohydroxyacid synthase inhibitors.

Item 11: The use or method of item 10, wherein the undesired vegetation is resistant to glyphosate.

Item 12: The use or method of items 9 to 11, wherein the undesired vegetation are dicotyledonous weeds.

Item 13: The use or method of item 12, wherein the dicotyledonous weeds are Conyza species.

Item 14: The use or method of items 9 to 11, wherein the undesired vegetation are volunteer crops.

Item 15: The use or method of item 14, wherein the volunteer crops are soybean, cotton, canola, alfalfa, sugarbeet and sunflower.

Item 16: The method for controlling undesired vegetation of anyone of items 6 to 15 comprising applying the composition as described in items 1 to 4 at least 4 days before crop seeding.

Item 17: The method for controlling undesired vegetation of items 6 to 16, which comprises repeated application of the composition as described in items 1 to 4.

Item 18: An herbicide formulation comprising a composition as described in any of items 1 to 4 and at least one solid or liquid carrier.

1-19. (canceled)

20. A method for controlling undesirable vegetation, which comprises allowing a herbicidal composition comprising:
a) a herbicide A, which is glyphosate or an agriculturally acceptable salt thereof,
b) a herbicide B which is saflufenacil or an agriculturally salt thereof, and
c) at least one herbicide C which is an imidazolinone or an agriculturally acceptable salt thereof;
to act on herbicide resistant plants or their habitat in crop plants.

21. The method of claim 20, wherein the crop plants are soybean.

22. The method of claim 20, wherein the undesirable vegetation is resistant to the herbicides such as glyphosate, dicamba, 2,4-dichlorophenoxyethanoic acid, glufosinate, ACCase inhibitors, HPPD inhibitors and/or acetohydroxyacid synthase inhibitors.

23. The method of claim 21, wherein the undesired vegetation is resistant to glyphosate and/or acetohydroxyacid synthase inhibitors.

24. The method of claim 20, wherein the undesired vegetation are volunteer corps or weeds.

24. The method of claim 23, wherein the weeds are monocotyledonous weeds or dicotyledonous weeds.

25. The method of claim 24, wherein the monocotyledonous weeds are Digitaria species.

26. The method of claim 25, wherein the monocotyledonous weeds are Digitaria insularis.

27. The method of claim 24, wherein the dicotyledonous weeds are Conyza species.

28. The method of claim 24, wherein the weeds are resistant to glyphosate.

29. The method of claim 23, wherein the volunteer crops are monocotyledonous volunteer crops or dicotyledonous volunteer crops.

30. The method of claim 29, wherein the volunteer crops are glyphosate resistant monocotyledonous volunteer crops.

31. The method of claim 30, wherein the volunteer crops are acetohydroxyacid synthase inhibitor resistant dicotyledonous volunteer crops.

32. The method of claim 20, wherein the at least one herbicide C is selected the group consisting of imazapyr, imazapic, and imazethapyr or their agriculturally acceptable salts.

33. The method of claim 32, wherein the at least one herbicide C is selected from the group consisting of imazapyr and imazapic or their agriculturally acceptable salts.

34. The method of claim 33, wherein the at least one herbicide C is a combination of imazapyr and imazapic or their agriculturally acceptable salts.

35. The method of claim 20 comprising applying the herbicidal composition at least 4 days before crop seeding.

36. The method of claim 20 which comprises repeated application of the herbicidal composition.
